(19) United States
(12) Patent Application Publication
(10) Pub. No.: US 2012/0083463 A1
(43) Pub. Date: Apr. 5, 2012

(54) Insecticidal and Fungicidal Active Compound Combinations

(75) Inventors: Michael MAUE, Langenfeld (DE); Friedrich August MÜHLTHAU, Bad Soden am Taunus (DE); Isabelle ADELT, Haan (DE); Markus HEIL, Leichlingen (DE); Peter JESCHKE, Bergisch Gladbach (DE); Tobias KAPFERER, Dusseldorf (DE); Alexander SUDAU, Leichlingen (DE); Heike HUNGENBERG, Langenfeld (DE)

(73) Assignee: Bayer CropScience AG, Monheim (DE)

(21) Appl. No.: 13/179,273

(22) Filed: Jul. 8, 2011

Related U.S. Application Data
(60) Provisional application No. 61/362,446, filed on Jul. 8, 2010.

(30) Foreign Application Priority Data
Jul. 8, 2010 (EP) 10168882.8

(51) Int. Cl. A01N 43/90; A01N 43/50; A01N 43/40; A01N 43/88; A01N 43/78; A01N 43/68; A01N 43/54; A01N 43/52; A01N 43/56; A01N 43/653; A01P 7/02; A01P 7/04; A01P 5/00; A01P 3/00; A01N 55/10

(52) U.S. Cl. 514/30; 514/63; 514/341; 514/357; 514/229.2; 514/342; 514/365; 514/245; 514/269; 514/355; 514/395; 514/406; 514/391; 514/275; 514/383

(57) ABSTRACT

The present invention relates to active compound combinations consisting, firstly, of a known halogen-substituted derivative (component A) and, secondly, of further known pesticidally active compounds (component B), which active compound combinations are suitable for controlling animal and microbial pests.

The present application relates to mixtures of halogen-substituted compounds (component A) with a component B comprising at least one insecticide or an acaricide or a nematicide or an antimicrobial compound. These active compound combinations are suitable for controlling animal or microbial pests and also as plant-invigorating agents.

The halogen-substituted compounds of component A are known from WO 2010/051926, and their activity for controlling animal pests has been described. However, the acaricidal and/or insecticidal and/or nematicidal activity and/or activity spectrum and/or the plant compatibility of the known compounds, in particular with respect to crop plants, is not always satisfactory.

The active compounds referred to in this description by their common name are known, for example, from “The Pesticide Manual” 14th Ed., British Crop Protection Council 2006, and the website http://www.alanwood.net/pesticides.

Component A of the active compound combinations according to the invention comprises at least one, preferably exactly one, compound selected from the formulae (Ia) to (Iv)

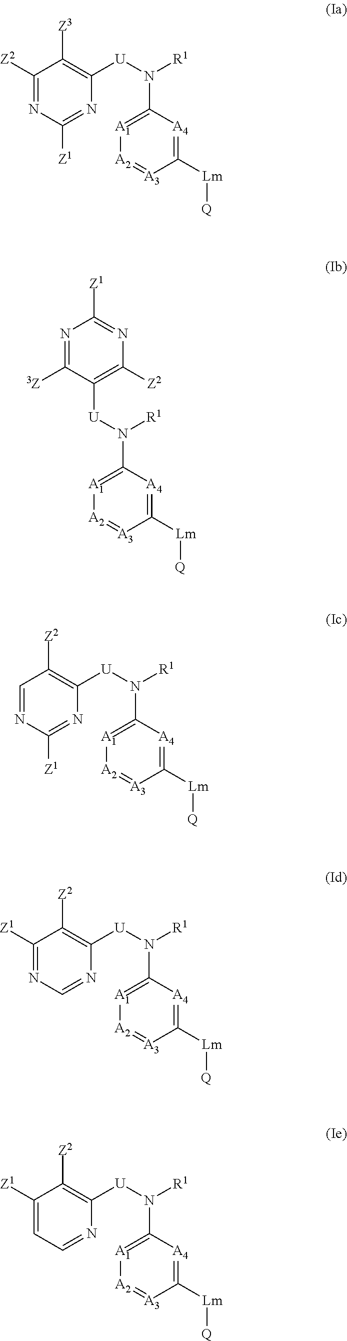

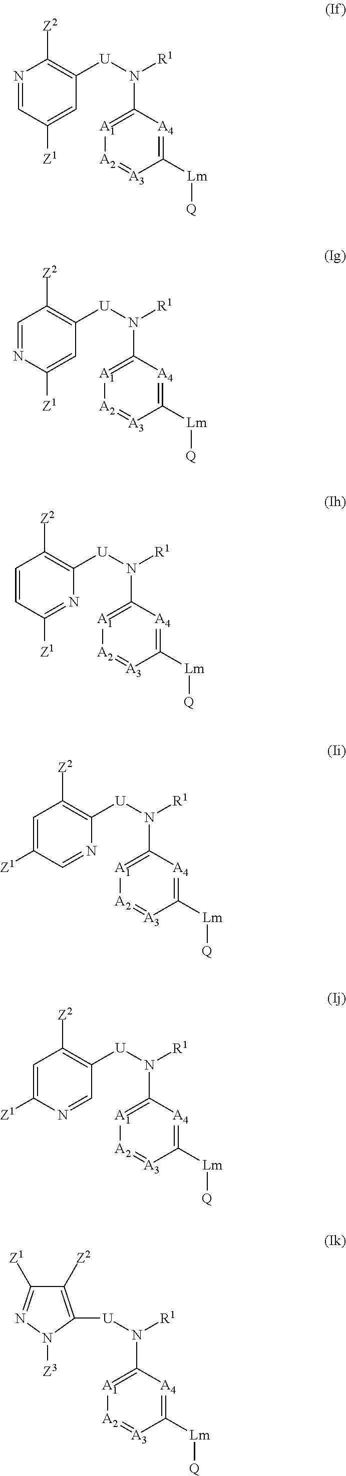

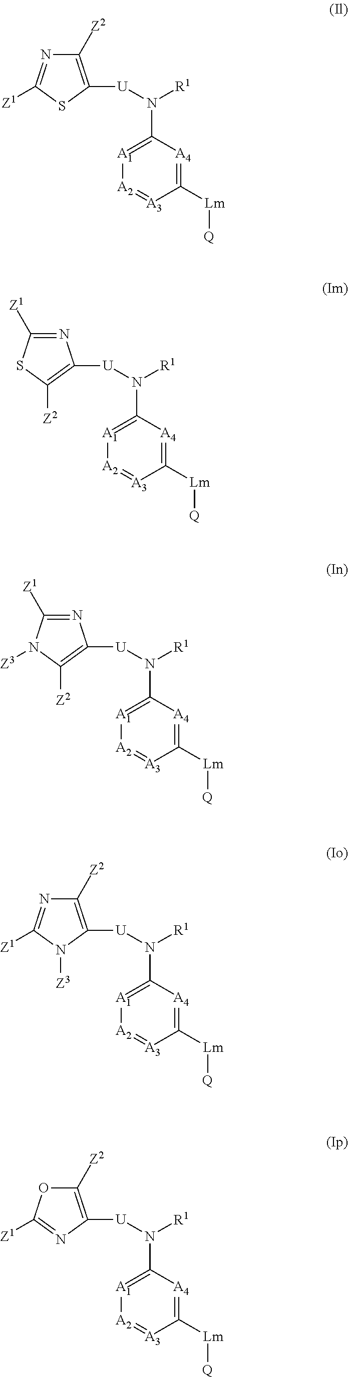

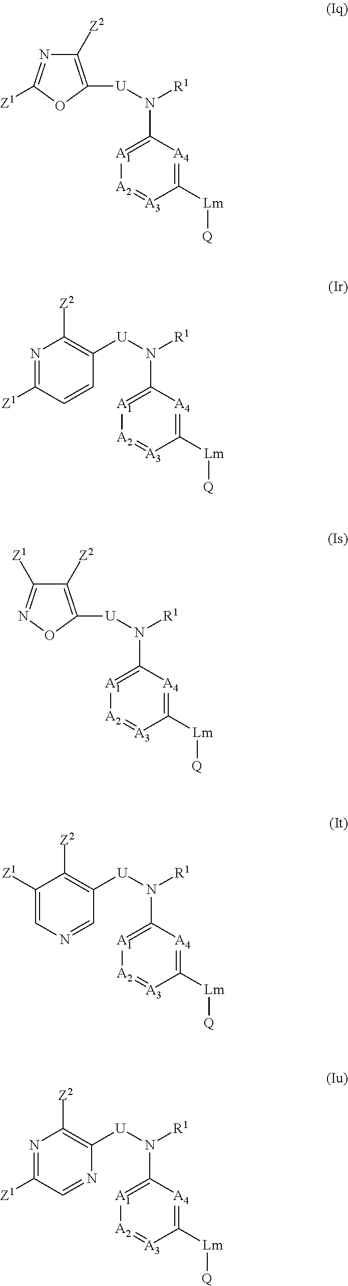

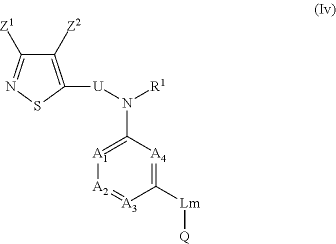

in which
R¹ represents hydrogen or the optionally substituted groupings C₁-C₆-alkyl, C₂-C₆-alkenyl, C₂-C₆-alkynyl, C₃-C₇-cycloalkyl, C₁-C₆-alkylcarbonyl, C₁-C₆-alkoxycarbonyl, cyano-C₁-C₂alkyl, aryl-(C₁-C₃)-alkyl, heteroaryl-(C₁-C₃)-alkyl;
A₁ represents CR² or nitrogen,
A₂ represents CR³ or nitrogen,
A₃ represents CR⁴ or nitrogen and
A₄ represents CR⁵ or nitrogen, where at most three of the chemical groupings A₁ to A₄ simultaneously represent nitrogen, and where
R², R³, R⁴ and R⁵ independently of one another represent hydrogen, halogen, CN, NO₂, optionally substituted C₁-C₆-alkyl, C₁-C₆-haloalkyl, C₁-C₆-cycloalkyl, C₃-C₆-halocycloalkyl, C₁-C₆-alkoxy, C₁-C₆-haloalkoxy, C₁-C₆-alkylthio, C₁-C₆-haloalkylthio, C₁-C₆-alkylsulphinyl, C₁-C₆-haloalkylsulphinyl, C₁-C₆-alkylsulphonyl, C₁-C₆-haloalkylsulphonyl, N—C₂-C₇-alkylaminocarbonyl, N—C₂-C₇-cycloalkylaminocarbonyl,
   if none of the groupings A₂ and A₃ represents nitrogen, R³ and R⁴ together with the carbon atom to which they are attached may form a 5- or 6-membered ring which contains 0, 1 or 2 nitrogen atoms and/or 0 or 1 oxygen atom and/or 0 or 1 sulphur atom, or
   if none of the groupings A₁ and A₂ represents nitrogen, R² and R³ together with the carbon atom to which they are attached may form a 6-membered ring which contains 0, 1 or 2 nitrogen atoms;
U represents C(═W), SO or SO₂;
W represents oxygen or sulphur;
L represents a bivalent chemical grouping selected from among the groupings —CH₂NHC(═W)—, —CH₂NR⁶C(═W)—, —C(—W)NH, —C(—W)NR⁶, —NH(C═W)NH—, —NH(C═W)NR⁶—, —NR⁶(C═W)NH—, —NR⁶(═W)NR⁶—, —C(═W)—, —C(═W)O—, —C(═W)OCH₂C(═W)—, —C(═W)OCH₂C(═W)NR⁶—, —C(═W)OCH₂C(═W)NHC(═W)NH—, —C(═W)OCH₂C(═W)NH—, —O—, —S(O)ₚ, and —CH₂—S(O)ₚ, —SO(═N—CN)— and —S(═N—CN)—, —C(═W)NHSO₂—, where
p may assume the value 0, 1 or 2 and
R⁶ represents hydrogen, C₁-C₆-alkyl, aryl(C₁-C₃)-alkyl, heteroaryl(C₁-C₃)-alkyl, C₂-C₇-alkylcarbonyl, C₂-C₇-alkoxycarbonyl;
m may assume the value 0 or 1;
Q represents hydrogen or the optionally substituted groupings C₁-C₆-alkyl, C₂-C₆-alkenyl, C₂-C₆-alkynyl, C₃-C₆-cycloalkyl, cyano-C₁-C₂-alkyl, C₁-C₅-heterocycloalkyl, C₁-C₄-alkoxy, C₄-C₇-alkylcycloalkyl, C₄-C₇-cycloalkylalkyl, C₂-C₇-alkylcarbonyl, C₁-C₆-alkylaldehyde, C₁-C₆-hydroxyalkyl, C₂-C₇-alkoxycarbonyl, C₁-C₆-haloalkyl, cyano, aryl-(C₁-C₃)-alkyl, heteroaryl-(C₁-C₃)-alkyl, or represents a grouping NR⁶R⁸, where
R⁸ is selected from the group consisting of hydrogen, C₁-C₆-alkyl, C₂-C₆-alkenyl, C₂-C₆-alkynyl, C₃-C₆-cycloalkyl, C₄-C₇-alkylcycloalkyl and C₄-C₇-cycloalkylalkyl;
Z represents hydrogen, chlorine, bromine, iodine, cyano, nitro or the optionally substituted groupings C₁-C₄-alkyl, C₁-C₄-alkenyl, C₁-C₄-alkynyl, C₁-C₄-haloalkyl, C₃-C₆-cycloalkyl, C₃-C₆-halocycloalkyl, C₁-C₄-alkoxy, C₁-C₄-haloalkoxy, C₁-C₄-haloalkylthio, C₁-C₄-haloalkylsulphinyl, C₁-C₄-alkylsulphonyl, C₁-C₄-haloalkylsulphonyl, N,N-di-(C₁-C₄)alkylamino, and optionally R¹⁸-substituted phenyl and pyridinyl;
R¹⁸ is selected from the group consisting of halogen, —OH, —NH₂, —COOH, —CN, —NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulphinyl, C₁-C₄-haloalkylsulphinyl, C₁-C₄-alkylsulphonyl, C₁-C₄-haloalkylsulphonyl, C₁-C₄-alkylamino, N,N-di-(C₁-C₄)alkylamino, C₁-C₄-alkylcarbonyl, C₁-C₄-alkoxycarbonyl, C₁-C₄-alkylaminocarbonyl and N,N-di-(C₁-C₄)alkylaminocarbonyl.

Furthermore
L, Q and R⁴ together with the carbon atoms to which they are attached may form an optionally substituted 5- or 6-membered ring which optionally contains 0, 1 or 2 nitrogen atoms and/or 0 or 1 oxygen atom and/or 0 or 1 sulphur atom.

Preference is given to compounds of the formulae (Ia) to (Iv) in which
R¹ represents hydrogen, methyl, ethyl, n-propyl, isopropyl, n-butyl, 2-butynyl, isobutyl, sec-butyl, tert-butyl, methoxymethyl, ethoxymethyl, propoxymethyl, methylcarbonyl, ethylcarbonyl, n-propylcarbonyl, allyl, propargyl, isopropylcarbonyl, sec-butylcarbonyl, tert-butylcarbonyl, methoxycarbonyl, ethoxycarbonyl, n-propoxycarbonyl, isopropoxycarbonyl, sec-butoxycarbonyl, tert-butoxycarbonyl, cyanomethyl, 2-cyanoethyl;
A₁ represents CR² or nitrogen,
A₂ represents CR³ or nitrogen,
A₃ represents CR⁴ or nitrogen and
A₄ represents CR⁵ or nitrogen, where at most three of the chemical groupings A₁ to A₄ simultaneously represent nitrogen, and where
R² and R⁵ independently of one another represent hydrogen, methyl, fluorine and chlorine and
R³ and R⁴ independently of one another represent hydrogen, fluorine, chlorine, bromine, CN, NO₂, methyl, ethyl, fluoromethyl, difluoromethyl, trifluoromethyl, 2,2,2-trifluoroethyl, methoxy, ethoxy, n-propoxy, 1-methylethoxy, fluoromethoxy, difluoromethoxy, chlorodifluoromethoxy, dichlorofluoromethoxy, trifluoromethoxy, 2,2,2-trifluoroethoxy, 2-chloro-2,2-difluoroethoxy, pentafluoroethoxy, methylsulphonyl, methylsulphinyl, trifluoromethylsulphonyl, trifluoromethylsulphinyl or N-cyclopropylaminocarbonyl; where
U represents C(═W), SO₂,
W represents oxygen,
L represents a bivalent chemical grouping selected from among the groupings —C(═O)NH, —C(═O)NR⁶, —C(═O)O—, —C(═O)OCH₂C(═O)—, —C(═O)OCH₂C(═O)NR⁶—, —C(═O)OCH₂C(═O)NHC(═O)NH—, —C(═O)OCH₂C(═O)NH—, —C(═W)NHSO₂—, where
R⁶ represents hydrogen, methyl, ethyl, n-propyl, isopropyl, n-butyl, isobutyl, sec-butyl, tert-butyl, methoxymethyl, ethoxymethyl, propoxymethyl, methylcarbonyl, ethylcarbonyl, n-propylcarbonyl, isopropylcarbonyl, sec-butylcarbonyl, tert-butylcarbonyl, methoxycarbonyl, ethoxycarbonyl, n-propoxycarbonyl, isopropoxycarbonyl, sec-butoxycarbonyl, tert-butoxycarbonyl, cyanomethyl, 2-cyanoethyl;
m assumes the value 1,
Q represents hydrogen, methyl, ethyl, n-propyl, 1-methylethyl, 1,1-dimethylethyl, 1-methylpropyl, 2-methylpropyl, 2-methylbutyl, hydroxymethyl, 2-hydroxypropyl, cyanomethyl, 2-cyanoethyl, 2-fluoroethyl, 2,2-difluoroethyl, 2,2,2-trifluoroethyl, 1-trifluoromethylethyl, 2,2-difluoropropyl, 2,2-dimethyl-3-fluoropropyl, cyclopropyl, cyclobutyl, cyclopentyl, cyclohexyl, 1-cyclopropylethyl, bis(cyclopropyl)methyl, 2,2-dimethylcyclopropylmethyl, 2-phenylcyclopropyl, 2,2-dichlorocyclopropyl, trans-2-chlorocyclopropyl, cis-2-chlorocyclopropyl, 2,2-difluorocyclopropyl, trans-2-fluorocyclopropyl, cis-2-fluorocyclopropyl, trans-4-hydroxycyclohexyl, 4-trifluoromethylcyclohexyl, prop-2-enyl, 2-methylprop-2-enyl, prop-2-ynyl, 1,1-dimethylbut-2-ynyl, 3-chloroprop-2-enyl, 3,3-dichloro-1,1-dimethylprop-2-enyl, oxetan-3-yl, isoxazol-3-ylmethyl, 1,2,4-triazol-3-ylmethyl, 3-methyloxetan-3-ylmethyl, benzyl, 2,6-difluorophenylmethyl, 3-fluorophenylmethyl, 2-fluorophenylmethyl, 2,5-difluorophenylmethyl, 1-phenylethyl, 4-chlorophenylethyl, 2-trifluoromethylphenylethyl, 1-pyridin-2-ylethyl, pyridin-2-ylmethyl, 5-fluoropyridin-2-ylmethyl, pyrimidin-2-ylmethyl, methoxy, 2-ethoxyethyl, 2-(methylsulphanyl)ethyl, 1-methyl-2-(ethylsulphanyl)ethyl, methoxycarbonyl, methoxycarbonylmethyl, NH₂, N-ethylamino, N-allylamino, N,N-dimethylamino, N,N-diethylamino; or
Q represents hydrogen, methyl, ethyl, n-propyl, 1-methylethyl, 1,1-dimethylethyl, 1-methylpropyl, 2-methylpropyl, 2-methylbutyl, hydroxymethyl, 2-hydroxypropyl, cyanomethyl, 2-cyanoethyl, 2-fluoroethyl, 2,2-difluoroethyl, 2,2,2-trifluoroethyl, 1-trifluoromethylethyl, 2,2-difluoropropyl, 2,2-dimethyl-3-fluoropropyl, cyclopropyl, cyclobutyl, cyclopentyl, cyclohexyl, 1-cyclopropylethyl, bis(cyclopropyl)methyl, 2,2-dimethylcyclopropylmethyl, 2-phenylcyclopropyl, 2,2-dichlorocyclopropyl, trans-2-chlorocyclopropyl, cis-2-chlorocyclopropyl, 2,2-difluorocyclopropyl, trans-2-fluorocyclopropyl, cis-2-fluorocyclopropyl, trans-4-hydroxycyclohexyl, 4-trifluoromethylcyclohexyl, prop-2-enyl, 2-methylprop-2-enyl, prop-2-ynyl, 1,1-dimethylbut-2-ynyl, 3-chloroprop-2-enyl, 3,3-dichloroprop-2-enyl, 3,3-dichloro-1,1-dimethylprop-2-enyl, oxetan-3-yl, isoxazol-3-ylmethyl, 1,2,4-triazol-3-ylmethyl, 3-methyloxetan-3-ylmethyl, benzyl, 2,6-difluorophenylmethyl, 3-fluorophenylmethyl, 2-fluorophenylmethyl, 2,5-difluorophenylmethyl, 1-phenylethyl, 4-chlorophenylethyl, 2-trifluoromethylphenylethyl, 1-pyridin-2-ylethyl, pyridin-2-ylmethyl, 5-fluoropyridin-2-ylmethyl, pyrimidin-2-ylmethyl, methoxy, 2-ethoxyethyl, 2-(methylsulphanyl)ethyl, 1-methyl-2-(ethylsulphanyl)ethyl, 2-methyl-1-(methylsulphanyl)propan-2-yl, methoxycarbonyl, methoxycarbonylmethyl, NH₂, N-ethylamino, N-allylamino, N,N-dimethylamino, N,N-diethylamino;
Z represents hydrogen, chlorine, bromine, iodine, cyano, nitro, methyl, ethyl, n-propyl, isopropyl, n-butyl, isobutyl, sec-butyl, tert-butyl, ethenyl, 1-propenyl, 2-propenyl, ethynyl, 1-propynyl, 1-butynyl, difluoromethyl, trichloromethyl, chlorodifluoromethyl, dichlorofluoromethyl, trifluoromethyl, chloromethyl, bromomethyl, 1-fluoroethyl, 1-fluoro-1-methylethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl, pentafluoro-tert-butyl, heptafluoro-n-propyl, heptafluoroisopropyl, nonafluoro-n-butyl, trifluoromethoxy-1,1,2,2-tetrafluoroethoxydifluoromethyl, trifluoromethylthio, trifluoromethylsulphinyl, trifluoromethylsulphonyl, methoxy, ethoxy, n-propoxy, trifluoromethoxy, difluoromethoxy, cyclopropyl, cyclobutyl, 2,2,2-trifluoroethoxy, 1-trifluoromethylethoxy, 3,3,3,2,2-pentafluoropropoxy, 4-fluorophenyl, 4-chlorophenyl, 4-trifluoromethylphenyl, 2,2,2-trifluoroethyl, 2,2-difluoro-1-methylcyclopropyl; or
Z represents hydrogen, chlorine, bromine, iodine, cyano, nitro, methyl, ethyl, n-propyl, isopropyl, n-butyl, isobutyl, sec-butyl, ten-butyl, ethenyl, 1-propenyl, 2-propenyl, ethynyl, 1-propynyl, 1-butynyl, difluoromethyl, trichloromethyl, chlorodifluoromethyl, dichlorofluoromethyl, trifluoromethyl, chloromethyl, bromomethyl, 1-fluoroethyl, 1-fluoro-1-methylethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl, pentafluoro-tert-butyl, heptafluoro-n-propyl, heptafluoro isopropyl, nonafluoro-n-butyl, trifluoromethoxy-1,1,2,2-tetrafluoroethoxydifluoromethyl, trifluoromethylthio, trifluoromethylsulphinyl, trifluoromethylsulphonyl, methoxy, ethoxy, n-propoxy, trifluoromethoxy, difluoromethoxy, cyclopropyl, cyclobutyl, 2,2,2-trifluoroethoxy, 1-trifluoromethylethoxy, 3,3,3,2,2-pentafluoropropoxy, 4-fluorophenyl, 4-chlorophenyl, 4-trifluoromethylphenyl, 2,2,2-trifluoroethyl, 2,2-difluoro-1-methylcyclopropyl, phenyl, methoxymethyl, cyclopropyl(fluoro)methyl, 2,4-dichlorophenyl, 4-trifluoromethoxyphenyl, 2-chlorophenyl, 3,5-bis(trifluoromethyl)phenyl, (1,1,1,3,3,3-hexafluoropropan-2-yl)oxy.

Furthermore
L, Q and R⁴ together with the carbon atoms to which they are attached may form an optionally substituted 5- or 6-membered ring which optionally contains 0, 1 or 2 nitrogen atoms and/or 0 or 1 oxygen atom and/or 0 or 1 sulphur atom.

Preferred as component A of the active compound combinations according to the invention are compounds of the general formulae (Ib), (Ic), (Ii), (Ij), (Ik), (Ir).

Component B comprises one or more compounds of groups (I-1) to (I-27) and/or one or more compounds of groups (F-1) to (F-14).

(I-1) Acetylcholinesterase (AChE) inhibitors, such as, for example,
carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.
(I-2) GABA-gated chloride channel antagonists, such as, for example,
organochlorines, for example chlordane and endosulfan (alpha-); or
fiproles (phenylpyrazoles), for example ethiprole, fipronil, pyrafluprole and pyriprole.
(I-3) Sodium channel modulators/voltage-dependent sodium channel blockers, such as, for example,
pyrethroids, for example acrinathrin, allethrin (d-cis-trans, d-trans), bifenthrin, bioallethrin, bioallethrin-S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers], esfenvalerate, etofenprox, fenpropathrin, fenvalerate, flucythrinate, flumethrin, fluvalinate (tau-), halfenprox, imiprothrin, metofluthrin, permethrin, phenothrin [1R)-trans-isomer], prallethrin, profluthrin, pyrethrins (pyrethrum), resmethrin, RU 15525, silafluofen, tefluthrin, tetramethrin [(1R)-isomers], tralomethrin, transfluthrin and ZXI 8901; or
DDT; or methoxychlor.
(I-4) Nicotinergic acetylcholine receptor, agonists, such as, for example,
neonicotinoids, for example acetamiprid, clothianidin, dinotefuran, imidacloprid, imidaclothiz, nitenpyram, thiacloprid, thiamethoxam; or
nicotine.
(I-5) Allosteric acetylcholine receptor modulators (agonists), such as, for example,
spinosyns, for example spinetoram and spinosad.
(I-6) Chloride channel activators, such as, for example,
avermectins/milbemycins, for example abamectin, emamectin benzoate, lepimectin and milbemectin.
(I-7) Juvenile hormone analogues, for example hydroprene, kinoprene, methoprene; or fenoxycarb; pyriproxyfen.
(I-8) Active compounds with unknown or non-specific mechanisms of action, such as, for example,
fumigants, for example methyl bromide and other alkyl halides; or
chloropicrin; sulphuryl fluoride; borax; tartar emetic.
(I-9) Selective antifeedants, for example pymetrozine; or flonicamid.
(I-10) Mite growth inhibitors, for example clofentezine, diflovidazin, hexythiazox etaxazole.
(I-11) Microbial disruptors of the insect gut membrane, such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1.
(I-12) Oxidative phosphorylation inhibitors, ATP disruptors, such as, for example, diafenthiuron; or
organotin compounds, for example azocyclotin, cyhexatin, fenbutatin oxide; or
propargite; tetradifon.
(I-13) Oxidative phosphorylation decouplers acting by interrupting the H proton gradient, such as, for example, chlorfenapyr and DNOC.
(I-14) Nicotinergic acetylcholine receptor antagonists, such as, for example, bensultap, cartap (hydrochloride), thiocylam, and thiosultap (sodium).
(I-15) Chitin biosynthesis inhibitors, type 0, such as, for example, benzoylureas, for example bistrifluoron, chlorfluazuron, diflubenzuron, flucycloxuron, flufenoxuron, hexaflumuron, lufenuron, novaluron, noviflumuron, teflubenzuron and triflumuron.
(I-16) Chitin biosynthesis inhibitors, type 1, such as, for example, buprofezin.
(I-17) Moulting disruptors, such as, for example, cyromazine.
(I-18) Ecdysone agonists/disruptors, such as, for example,
diacylhydrazines, for example chromafenozide, halofenozide, methoxyfenozide and tebufenozide.
(I-19) Octopaminergic agonists, such as, for example, amitraz.
(I-20) Complex-III electron transport inhibitors, such as, for example, hydramethylnon; acequinocyl; fluacrypyrim.
(I-21) Complex-I electron transport inhibitors, for example from the group of the MET1 acaricides, for example fenazaquin, fenpyroximate, pyrimidifen, pyridaben, tebufenpyrad, tolfenpyrad; or
rotenone (derris).
(I-22) Voltage-dependent sodium channel blockers, for example indoxacarb; metaflumizone.
(I-23) Inhibitors of acetyl-CoA carboxylase, such as, for example, tetronic acid derivatives, for example spirodiclofen and spiromesifen; or tetramic acid derivatives, for example spirotetramat.
(I-24) Complex-IV electron transport inhibitors, such as, for example, phosphines, for example aluminium phosphide, calcium phosphide, phosphine, zinc phosphide; or cyanide.
(I-25) Complex-II electron transport inhibitors, such as, for example; cyenopyrafen.
(I-26) Ryanodine receptor effectors, such as, for example, diamides, for example flubendiamide, chlorantraniliprole (Rynaxypyr), cyantraniliprole (Cyazypyr) and also 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934) or methyl 2-[3,5-dibromo-2-([3-bromo-1-(3-chloropyridin-2-yl)-1H-pyrazol-5-yl]carbonyl}amino)benzoyl]-1,2-dimethylhydrazinecarboxylate (known from WO2007/043677).
(I-27) Further active compounds with unknown mechanism of action, such as, for example, azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulphonyl]-1,3-thiazole), flufenerim, pyridalyl and pyrifluquinazon; and also products based on Bacillus firmus (I-1582, BioNeem, Votivo) and also the known active compounds below 4-{[(6-bromopyrid-3-yl)methyl](2-fluoroethyl)amino}furan-2(5H)-one (known from WO 2007/115644), 4-{[(6-fluoropyrid-3-yl)methyl](2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino} furan-2(5H)-one (known from EP-A-0 539 588), 4-{[(6-chloropyrid-3-yl)methyl](methyl)amino}furan-2(5H)-one (known from EP-A-0 539 588), [(6-chloropyridin-3-yl)methyl](methyl)oxido-λ⁴-sulphanylidenecyanamide (known from WO 2007/149134), [1-(6-chloropyridin-3-yl)ethyl](methyl)oxido-λ⁴-sulphanylidenecyanamide (known from WO 2007/149134) and its diastereomers (A) and (B)

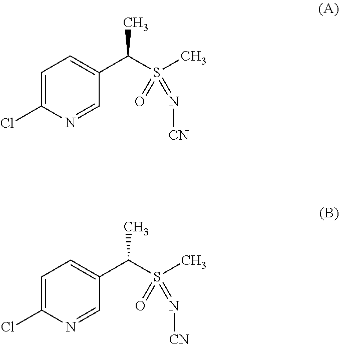

(also known from WO 2007/149134), [(6-trifluoromethylpyridin-3-yl)methyl](methyl)oxido-λ⁴-sulphanylidenecyanamide (known from WO 2007/095229), sulfoxaflor (also known from WO 2007/149134), 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911), 1-[2-fluoro-4-methyl-5-[(2,2,2-trifluoroethyl)sulphinyl]phenyl]-3-(trifluoromethyl)-1H-1,2,4-triazol-5-amine (known from WO 2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO 2006/129714), 2-cyano-3-(difluoromethoxy)-N-ethylbenzenesulphonamide (known from WO2005/035486), N-[1-(2,3-dimethylphenyl)-2-(3,5-dimethylphenyl)ethyl]-4,5-dihydro-2-thiazoleamine (known from WO2008/104503).
(F-1) Nucleic acid synthesis inhibitors, such as, for example, benalaxyl, benalaxyl-M, bupirimate, clozylacon, dimethirimol, ethirimol, furalaxyl, hymexazol, metalaxyl, metalaxyl-M, ofurace, oxadixyl and oxolinic acid.
(F-2) Mitosis and cell division inhibitors, such as, for example, benomyl, carbendazim, chlorfenazole, dicthofencarb, ethaboxam, fuberidazole, pencycuron, thiabendazole, thiophanate, thiophanate-methyl and zoxamide.
(F-3) Respiration inhibitors (respiratory chain inhibitors), such as, for example, diflumetorim as inhibitor at complex I of the respiratory chain; bixafen, boscalid, carboxin, fenfuram, flutolanil, fluopyram, furametpyr, furmecyclox, isopyrazam (mixture of the syn-epimeric racemate 1RS,4SR,9RS and the anti-epimeric racemate 1RS,4SR,9SR), isopyrazam (syn-epimeric racemate 1RS,4SR,9RS), isopyrazam (syn-epimeric enantiomer 1R,4S,9R), isopyrazam (syn-epimeric enantiomer 1S,4R,9S), isopyrazam (anti-epimeric racemate 1RS,4SR,9SR), isopyrazam (anti-epimeric enantiomer 1R,4S,9S), isopyrazam (anti-epimeric enantiomer 1S,4R,9R),
mepronil, oxycarboxin, penflufen, penthiopyrad, sedaxane, thifluzamide as inhibitors at complex II of the respiratory, chain; amisulbrom, azoxystrobin, cyazofamid, dimoxystrobin, enestroburin, famoxadone, fenamidone, fluoxastrobin, kresoxim-methyl, metominostrobin, orysastrobin, picoxystrobin, pyraclostrobin, pyraoxystrobin, pyrametostrobin, pyribencarb, trifloxystrobin as inhibitors at complex III of the respiratory chain.
(F-4) Decouplers, such as, for example, binapacryl, dinocap, fluazinam and meptyldinocap.
(F-5) ATP production inhibitors, such as for example, fentin acetate, fentin chloride, fentin hydroxide and silthiofam.
(F-6) Amino acid and protein biosynthesis inhibitors, such as, for example, andoprim, blasticidin-S, cyprodinil, kasugamycin, kasugamycin hydrochloride hydrate, mepanipyrim and pyrimethanil.
(F-7) Signal transduction inhibitors, such as, for example, fenpiclonil, fludioxonil and quinoxyfen.
(F-8) Lipid and membrane synthesis inhibitor S, such as, for example, biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl and vinclozolin.
(F-9) Ergosterol biosynthesis inhibitors, such as, for example, aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulphate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafin, tetraconazole, triadimefon, triadimenol, tridemorph, triflumizole, triforin, triticonazole, uniconazole, viniconazole and voriconazole.
(F-10) Cell wall synthesis inhibitors, such as, for example, benthiavalicarb, dimethomorph, flumorph, iprovalicarb, mandipropamide, polyoxins, polyoxorim, prothiocarb, validamycin A and valefenalate.
(F-11) Melanin biosynthesis, inhibitors, such as, for example, carpropamid, diclocymet, fenoxanil, fthalide, pyroquilon and tricyclazole.
(F-12) Resistance inductors such as, for example, acibenzolar-5-methyl, probenazole and tiadinil.
(F-13) Compounds with multisite activity such as, for example, Bordeaux mixture, captafol, captan, chlorothalonil, copper naphthenate, copper oxide, copper oxychloride, copper preparations such as copper hydroxide, copper sulphate, dichlofluanid, dithianone, dodine and its free base, ferbam, fluorofolpet, folpet, guazatine, guazatine acetate, iminoctadine, iminoctadine albesilate, iminoctadine triacetate, mancopper, mancozeb, maneb, metiram, zinc metiram, copper oxine, propamidin, propineb, sulphur and sulphur preparations such as, for example, calcium polysulphide, thiram, tolylfluanid, zineb and ziram.
(F-14) Other compounds such as, for example, 2,3-dibutyl-6-chlorothieno[2,3-d]pyrimidin-4(3H)-one, ethyl (2Z)-3-amino-2-cyano-3-phenylprop-2-enoate, N-[2-(1,3-dimethylbutyl)phenyl]-5-fluoro-1,3-dimethyl-1H-pyrazole-4-carboxamide, 3-(difluoromethyl)-1-methyl-N-(3′,4′,5′-trifluorobiphenyl-2-yl)-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, (2E)-2-(2-{[6-(3-chloro-2-methylphenoxy)-5-fluoropyrimidin-4-yl]oxy}phenyl)-2-(methoxyimino)-N-methylethanamide, (2E)-2-(2-[({[(2E,3E)-4-(2,6-dichlorophenyl)but-3-en-2-ylidene]amino}oxy)methyl]phenyl)-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]-ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[{[(1E)-1-(3-{[(E)-1-fluoro-2-phenylethenyl]oxy}phenyl)ethylidene}amino]oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylic acid, N-ethyl-N-methyl-N′-{2-methyl-5-(trifluoromethyl)-4-[3-(trimethylsilyl)propoxy]phenyl}imidoformamide, N′-(5-(difluoromethyl)-2-methyl-4-[3-(trimethylsilyl)propoxy]phenyl}-N-ethyl-N-methylimidoformamide, O-{1-[(4-methoxyphenoxy)methyl]-2,2-dimethylpropyl) 1H-imidazole-1-carbothioate, N-[2-(4-[3-(4-chlorophenyl)prop-2-yn-1-yl]oxy}-3-methoxyphenyl)ethyl]-N²-(methylsulphonyl)valinamide, 5-chloro-7-(4-methylpiperidin-1-yl)-6-(2,4,6-trifluorophenyl)[1,2,4]triazolo[1,5-a]pyrimidine, 5-amino-1,3,4-thiadiazole-2-thiol, propamocarb-fosetyl, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulphonyl)pyridine, 2-butoxy-6-iodo-3-propyl-4H-chromen-4-one, 2-phenylphenol and its salts, 3-(difluoromethyl)-1-methyl-N-[2-(1,1,2,2-tetrafluoroethoxy)phenyl]-1H-pyrazole-4-carboxamide, 3,4,5-trichloropyridin-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 8-hydroxyquinoline, 8-hydroxyquinoline sulphate, tebufloquin, 5-methyl-6-octyl-3,7-dihydro[1,2,4]triazolo[1,5-a]pyrimidine-7-amine, 5-ethyl-6-octyl-3,7-dihydro[1,2,4]triazolo[1,5-a]pyrimidine-7-amine, ametoctradin, benthiazole, bethoxazin, capsimycin, carvone, chinomethionat, chloroneb, cufraneb, cyflufenamid, cymoxanil, cyprosulfamide, dazomet, debacarb, dichlorophen, diclomezin, dicloran, difenzoquat, difenzoquat methylsulphate, diphenylamine, ecomat, ferimzone, flumetover, fluopicolid, fluoroimide, flusulfamide, flutianil, fosetyl-aluminium, fosetyl-calcium, fosetyl-sodium, hexachlorobenzene, irumamycin, isotianil, methasulfocarb, methyl (2E)-2-{2-[{cyclopropyl[(4-methoxyphenyl)imino]methyl}thio)methyl]phenyl}-3-methoxyacrylate, methyl isothiocyanate, metrafenon, (5-chloro-2-methoxy-4-methylpyridin-3-yl)(2,3,4-trimethoxy-6-methylphenyl)methanone, mildiomycin, tolnifanid, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-d fluorophenyl]methyl}-2-phenylacetamide, natamycin, nickel dimethyldithiocarbamate, nitrothal-isopropyl, octhilinone, oxamocarb, oxyfenthiin, pentachlorophenol and its salts, phenazin-1-carboxylic acid, phenothrin, phosphoric acid and its salts, propamocarb fosetylate, propanosine-sodium, proquinazid, pyrrolnitrin, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N′-prop-2-yn-1-ylthiophene-2-sulphonohydrazide, zarilamid, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, 3-(difluoromethyl)-N-[4-fluoro-2-(1,1,2,3,3,3-hexafluoropropoxy)phenyl]-1-methyl-1H-pyrazole-4-carboxamide and pentyl-{6-[({[(1-methyl-1H-tetrazol-5-yl)(phenyl)methylidene]amino}oxy)methyl]pyridin-2-yl}carbamate.

Preferred insecticidally, acaricidally or nematicidally active compounds within component B are:

acrinathrin, alpha-cypermethrin, betacyfluthrin, cyhalothrin, cypermethrin, deltamethrin
csfenvalcrate, etofenprox, fenpropathrin, fenvalerate, flucythrinat, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (Rynaxypyr), Cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, fenamiphos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, metamidophos, methiocarb, sulfoxaflor.

Preference is furthermore given to active compound combinations in which component A is selected from among compounds of the general formulae (Ib), (Ic), (Ii), (II), (Ik), (Ir) and component B is selected from the group consisting of

amidoflumet (II-29-1), azadirachtin (II-29-2), benclothiaz (II-29-3), benzoximate (II-29-4), bifenazate (II-29-5), bromopropylate (II-29-6), chinomethionat (II-29-7), cryolite (II-29-8), cyantraniliprole (cyazypyr) (II-29-9), cyflumetofen (II-29-10), dicofol (II-29-11), diflovidazin (II-29-12), fluensulphone (II-29-13), flufenerim (II-29-14), flufiprole (II-29-15), fluopyram (II-29-16), fufenozide (II-29-17), imidaclothiz (II-29-18), iprodione (II-29-19), pyridalyl (II-29-20), pyrifluquinazon (II-29-21) and iodmethane (II-29-22); furthermore preparations based on Bacillus firmus (in particular strain CNCM I-1582, for example VOTiVO™, BioNem) (II-29-23) and the following known active compounds:
3-Bromo-N-{2-bromo-4-chloro-6-[1-cyclopropylethyl)carbamoyl]phenyl}-1-(3-chloropyridin-2-yl)-1H-pyrazole-5-carboxamide (II-29-24) (known from WO2005/077934), 4-{[(6-bromopyrid-3-yl)methyl](2-fluoroethyl)amino}furan-2(5H)-one (II-29-25) (known from WO2007/115644), 4-{[(6-fluoropyrid-3-yl)methyl](2,2-difluoroethyl)amino}furan-2(5H)-one (II-29-26) (known from WO2007/115644), 4-{[(2-chloro-1,3-thiazol-5-yl)methyl](2-fluoroethyl)amino}furan-2(5H)-one (II-29-27) (known from WO2007/115644), 4-{[(6-chloropyrid-3-yl)methyl](2-fluoroethyl)amino}furan-2(5H)-one (II-29-28) (known from WO2007/115644), 4-{[(6-chloropyrid-3-yl)methyl](2,2-difluoroethyl)amino}furan-2(5H)-one (II-29-29) (known from WO2007/115644), 4-{[(6-chloro-5-fluoropyrid-3-yl)methyl](methyl)amino}furan-2(5H)-one (II-29-30) (known from WO2007/115643), 4-{[(5,6-dichloropyrid-3-yl)methyl](2-fluoroethyl)amino}furan-2(5H)-one (II-29-31) (known from WO2007/115646), 4-{[(6-chloro-5-fluoropyrid-3-yl)methyl](cyclopropyl)amino}furan-2(5H)-one (II-29-32) (known from WO2007/115643), 4-{[(6-chloropyrid-3-yl)methyl](cyclopropyl)amino}furan-2(5H)-one (II-29-33) (known from EP-A-0 539 588), 4-{[(6-chloropyrid-3-yl)methyl](methyl)amino}furan-2(5H)-one (II-29-34) (known from EP-A-0539 588), {[1-(6-chloropyridin-3-yl)ethyl](methyl)oxido-λ⁴-sulphanylidene}cyanamide (II-29-35) (known from WO2007/149134) and its diastereomers {[(1R)-1-(6-chloropyridin-3-yl)ethyl](methyl)oxido-λ⁴-sulphanylidene}cyanamide (A) (II-29-36) and {(1S)-1-(6-chloropyridin-3-yl)ethyl](methyl)oxido-λ⁴-sulphanylidene}cyanamide (B) (II-29-37) (likewise known from WO2007/149134) and also sulphoxaflor (II-29-38) (likewise known from WO2007/149134) and its diastereomers[(R)-methyl(oxido){(1R)-1-[6-(trifluoromethyl)pyridin-3-yl]ethyl}-λ⁴-sulphanylidene]cyanamide (A1) (II-29-39) and [(S)-methyl(oxido){(1S)-1-[6-(trifluoromethyl)pyridin-3-yl]ethyl}-λ⁴-sulphanylidene]cyanamide (A2) (II-29-40), referred to as diastereomer group A (known from WO 2010/074747, WO 2010/074751), [(R)-methyl(oxido){(1S)-1-[6-(trifluoromethyl)pyridin-3-yl]ethyl}-λ⁴-sulphanylidene]cyanamide (B1) (II-29-41) and [(S)-methyl(oxido) {(1R)-1-[6-(trifluoromethyl)pyridin-3-yl]ethyl}-λ⁴-sulphanylidene]cyanamide (B2) (II-29-42), referred as diastereomer group B (likewise known from WO 2010/074747, WO 2010/074751) and 11-(4-chloro-2,6-dimethylphenyl)-2-hydroxy-1,4-dioxa-9-azadispiro[4.2.4.2.]tetradec-11-en-10-one (II-29-43) (known from WO2006/089633), 3-(4′-fluoro-2,4-dimethylbiphenyl-3-yl)-4-hydroxy-8-oxa-1-azaspiro[4.5]dec-3-en-2-one (II-29-44) (known from WO2008/067911), 1-{2-fluoro-4-methyl-5-[(2,2,2-trifluoroethyl)sulphinyl]phenyl}-3-(trifluoromethyl)-1H-1,2,4-triazole-5-amine (II-29-45) (known from WO2006/043635), [(3S,4aR,2R,12aS,12bS)-3-[(cyclopropylcarbonyl)oxy]6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (II-29-46) (known from WO2008/066153), 2-cyano-3-(difluoromethoxy)-N,N-dimethylbenzenesulphonamide (II-29-47) (known from WO2006/056433), 2-cyano-3-(difluoromethoxy)-N-methylbenzenesulphonamide (II-29-48) (known from WO2006/100288), 2-cyano-3-(difluoromethoxy)-N-ethylbenzenesulphonamide (II-29-49) (known from WO2005/035486), 4-(difluoromethoxy)-N-ethyl-N-methyl-1,2-benzothiazole-3-amine 1,1-dioxide (II-29-50) (known from WO2007/057407), N-[1-(2,3-dimethylphenyl)-2-(3,5-dimethylphenyl)ethyl]-4,5-dihydro-1,3-thiazole-2-amine (II-29-51) (known from WO2008/104503), {1′-[(2E)-3-(4-chlorophenyl)prop-2-en-1-yl]-5-fluorospiro[indole-3,4′-piperidine]-1(2H)-yl}(2-chloropyridin-4-yl)methanone (II-29-52) (known from WO2003/106457), 3-(2,5-dimethylphenyl)-4-hydroxy-8-methoxy-1,8-diazaspiro[4.5]dec-3-en-2-one (II-29-53) (known from WO02009/049851), 3-(2,5-dimethylphenyl)-8-methoxy-2-oxo-1,8-diazaspiro[4.5]dec-3-en-4-yl ethyl carbonate (II-29-54) (known from WO2009/049851), 4-(but-2-yn-1-yloxy)-6-(3,5-dimethylpiperidin-1-yl)-5-fluoropyrimidine (II-29-55) (known from WO2004/099160), (2,2,3,3,4,4,5,5-octafluoropentyl)(3,3,3-trifluoropropyl)malononitrile (II-29-56) (known from WO2005/063094), (2,2,3,3,4,4,5,5-octafluoropentyl)(3,3,4,4,4-pentafluorobutyl)malononitrile (II-29-57) (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (II-29-58) (known from WO2007/040280), 2-ethyl-7-methoxy-3-methyl-64[(2,2,3,3-tetrafluoro-2,3-dihydro-1,4-benzodioxin-6-yl)oxy]quinolin-4-yl methyl carbonate (II-29-59) (known from JP2008/110953), 2-ethyl-7-methoxy-3-methyl-64(2,2,3,3-tetrafluoro-2,3-dihydro-1,4-benzodioxin-6-yl)oxy]quinolin-4-yl acetate (II-29-60) (known from JP2008/110953), PF1364 (CAS-Reg. No. 1204776-60-2) (II-29-61) (known from JP2010/018586), 545-(3,5-dichlorophenyl)-5-(trifluoromethyl)-4,5-dihydro-1,2-oxazol-3-yl]-2-(1H-1,2,4-triazol-1-yl)benzonitrile (II-29-62) (known from WO2007/075459), 5-[5-(2-chloropyridin-4-yl)-5-trifluoromethyl)-4,5-dihydro-1,2-oxazol-3-yl]-2-(1H-1,2,4-triazol-1-yl)benzonitrile (II-29-63) (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoro-ethyl)amino]ethyl}benzamide (II-29-64) (known from WO2005/085216), 4-{[(6-chloropyridin-3-yl)methyl](cyclopropyl)amino}-1,3-oxazol-2(5H)-one (II-29-65), 4-([(6-chloropyridin-3-yl)methyl](2,2-difluoroethyl)amino}-1,3-oxazol-2(5H)-one (II-29-66), 4-{[(6-chloropyridin-3-yl)methyl](methyl)amino}-1,3-oxazol-2(5H)-one (II-29-67), 4-{[1(6-chloropyridin-3-yl)methyl](methyl)amino}-1,3-oxazol-2(5H)-one (II-29-68) (all known from WO2010/005692), NNI-0711 (II-29-69) (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (II-29-70) (known from WO2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (II-29-71) (known from WO2005/085216), methyl 2-[2-({([3-bromo-1-(3-chloropyridin-2-yl)-1H-pyrazol-5-yl]carbonyl}amino)-5-cyano-3-methylbenzoyl]-2-ethylhydrazinecarboxylate (II-29-72) (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (II-29-73) (known from WO2005/085216), methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate (II-29-74) (known from WO2005/085216), methyl 2-[3,5-dibromo-2-([3-bromo-1-(3-chloropyridin-2-yl)-1H-pyrazol-5-yl]carbonyl}amino)benzoyl]-2-ethylhydrazinecarboxylate (II-29-75) (known from WO2005/085216), (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine (II-29-76) (known from WO2007/101369), 2-{6-fluoropyridin-3-yl)-1,3-thiazol-5-yl]pyridin-2-yl}pyrimidine (II-29-77) (known from WO2010/006713), 2-{6-[2-(pyridin-3-yl)-1,3-thiazol-5-yl]pyridin-2-yl)pyrimidine (II-29-78) (known from WO2010/006713), 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide (II-29-79) (known from WO2010/069502), 1-(3-chloropyridin-2-yl)-N-[4-cyano-2-methyl-6-(methylcarbamoyl)phenyl]-3-([5-(trifluoromethyl)-2H-tetrazol-2-yl]methyl}-1H-pyrazole-5-carboxamide (II-29-80) (known from WO02010/069502), N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide (II-29-81) (known from WO2010/069502), N-[2-(tert-butylcarbamoyl)-4-cyano-6-methylphenyl]-1-(3-chloropyridin-2-yl)-3-{([5-(trifluoromethyl)-2H-tetrazol-2-yl]methyl}-1H-pyrazolo-5-carboxamide (II-29-82) (known from WO2010/069502).

Preferred antimicrobially active compounds within component 13 are:

azoxystrobin, boscalid, penflufen, carbendazim, carboxin, fenamidone, fludioxonil, fluopicolide, fluoxastrobin, fluquinconazole, flutriafol, ipconazole, iprodione, isotianil, mefenoxam, metalaxyl, metominostrobin, pencycuron, prochloraz, prothioconazole, pyraclostrobin, pyrimethanil, sedaxane, silthiopham, tebuconazole, thiram, tolylfluanid, triadimenol, triazoxide, trifloxystrobin, triflumuron, triticonazole

Preference is given to active compound combinations (Nos. 1 to 144) in which an active compound of component A is combined with the following active compounds of component B in the mixing ratios given in Table A. These active compound combinations are shown in Table A below. The mixing ratios in the table are weight ratios. The ratio is to be understood as meaning component A to component B.

TABLE A

| | Mixing partner for | | particularly | very particularly |
|---|---|---|---|---|
| | component A | preferred | preferred | preferred |
| No. | (=component B) | mixing ratio | mixing ratio | mixing ratio |
| 1. | acrinathrin | 125:1 to 1:125 | 25:1 to 1:25 | 5:1 to 1:5 |
| 2. | alpha-cypermethrin | 125:1 to 1:125 | 25:1 to 1:25 | 5:1 to 1:5 |
| 3. | betacyfluthrin | 125:1 to 1:125 | 25:1 to 1:25 | 5:1 to 1:5 |
| 4. | cyhalothrin | 125:1 to 1:125 | 25:1 to 1:25 | 5:1 to 1:5 |
| 5. | cypermethrin | 125:1 to 1:125 | 25:1 to 1:25 | 5:1 to 1:5 |
| 6. | deltamethrin | 125:1 to 1:125 | 25:1 to 1:25 | 5:1 to 1:5 |
| 7. | esfenvalerate | 125:1 to 1:125 | 25:1 to 1:25 | 5:1 to 1:5 |
| 8. | etofenprox | 125:1 to 1:125 | 25:1 to 1:25 | 5:1 to 1:5 |
| 9. | fenpropathrin | 125:1 to 1:125 | 25:1 to 1:25 | 5:1 to 1:5 |
| 10. | fenvalerate | 125:1 to 1:125 | 25:1 to 1:25 | 5:1 to 1:5 |
| 11. | flucythrinate | 125:1 to 1:125 | 25:1 to 1:25 | 5:1 to 1:5 |
| 12.a | lambda-cyhalothrin | 125:1 to 1:125 | 25:1 to 1:25 | 5:1 to 1:5 |
| 12.b | gamma-cyhalothrin | 125:1 to 1:125 | 25:1 to 1:25 | 5:1 to 1:5 |
| 13. | permethrin | 125:1 to 1:125 | 25:1 to 1:25 | 5:1 to 1:5 |
| 14. | tau-fluvalinate | 125:1 to 1:125 | 25:1 to 1:25 | 5:1 to 1:5 |
| 15. | transfluthrin | 125:1 to 1:125 | 25:1 to 1:25 | 5:1 to 1:5 |
| 16. | zeta-cypermethrin | 125:1 to 1:125 | 25:1 to 1:25 | 5:1 to 1:5 |
| 17. | cyfluthrin | 125:1 to 1:125 | 25:1 to 1:25 | 5:1 to 1:5 |
| 18. | bifenthrin | 125:1 to 1:125 | 25:1 to 1:25 | 5:1 to 1:5 |
| 19. | tefluthrin | 125:1 to 1:125 | 25:1 to 1:25 | 5:1 to 1:5 |
| 20. | eflusilanat | 125:1 to 1:125 | 25:1 to 1:25 | 5:1 to 1:5 |
| 21. | fubfenprox | 125:1 to 1:125 | 25:1 to 1:25 | 5:1 to 1:5 |
| 22. | pyrethrin | 125:1 to 1:125 | 25:1 to 1:25 | 5:1 to 1:5 |
| 23. | resmethrin | 125:1 to 1:125 | 25:1 to 1:25 | 5:1 to 1:5 |
| 24. | imidacloprid | 125:1 to 1:125 | 25:1 to 1:25 | 5:1 to 1:5 |
| 25. | acetamiprid | 125:1 to 1:125 | 25:1 to 1:25 | 5:1 to 1:5 |
| 26. | thiamethoxam | 125:1 to 1:125 | 25:1 to 1:25 | 5:1 to 1:5 |
| 27. | nitenpyram | 125:1 to 1:125 | 25:1 to 1:25 | 5:1 to 1:5 |
| 28. | thiacloprid | 125:1 to 1:125 | 25:1 to 1:25 | 5:1 to 1:5 |
| 29. | dinotefuran | 125:1 to 1:125 | 25:1 to 1:25 | 5:1 to 1:5 |
| 30. | clothianidin | 125:1 to 1:125 | 25:1 to 1:25 | 5:1 to 1:5 |
| 31. | imidaclothiz | 125:1 to 1:125 | 25:1 to 1:25 | 5:1 to 1:5 |
| 32. | chlorfluazuron | 125:1 to 1:125 | 25:1 to 1:25 | 5:1 to 1:5 |
| 33. | diflubenzuron | 125:1 to 1:125 | 25:1 to 1:25 | 5:1 to 1:5 |
| 34. | lufenuron | 125:1 to 1:125 | 25:1 to 1:25 | 5:1 to 1:5 |
| 35. | teflubenzuron | 125:1 to 1:125 | 25:1 to 1:25 | 5:1 to 1:5 |
| 36. | triflumuron | 125:1 to 1:125 | 25:1 to 1:25 | 5:1 to 1:5 |
| 37. | novaluron | 125:1 to 1:125 | 25:1 to 1:25 | 5:1 to 1:5 |
| 38. | flufenoxuron | 125:1 to 1:125 | 25:1 to 1:25 | 5:1 to 1:5 |
| 39. | hexaflumuron | 125:1 to 1:125 | 25:1 to 1:25 | 5:1 to 1:5 |
| 40. | bistrifluoron | 125:1 to 1:125 | 25:1 to 1:25 | 5:1 to 1:5 |
| 41. | noviflumuron | 125:1 to 1:125 | 25:1 to 1:25 | 5:1 to 1:5 |
| 42. | buprofezin | 625:1 to 1:625 | 125:1 to 1:125 | 25:1 to 1:25 |
| 43. | cyromazine | 125:1 to 1:125 | 25:1 to 1:25 | 5:1 to 1:5 |
| 44. | methoxyfenozide | 125:1 to 1:125 | 25:1 to 1:25 | 5:1 to 1:5 |
| 45. | tebufenozide | 125:1 to 1:125 | 25:1 to 1:25 | 5:1 to 1:5 |
| 46. | halofenozide | 125:1 to 1:125 | 25:1 to 1:25 | 5:1 to 1:5 |
| 47. | chromafenozide | 125:1 to 1:125 | 25:1 to 1:25 | 5:1 to 1:5 |
| 48. | endosulfan | 125:1 to 1:125 | 25:1 to 1:25 | 5:1 to 1:5 |
| 49. | fipronil | 125:1 to 1:125 | 25:1 to 1:25 | 5:1 to 1:5 |
| 50. | ethiprole | 125:1 to 1:125 | 25:1 to 1:25 | 5:1 to 1:5 |
| 51. | pyrafluprole | 125:1 to 1:125 | 25:1 to 1:25 | 5:1 to 1:5 |
| 52. | pyriprole | 125:1 to 1:125 | 25:1 to 1:25 | 5:1 to 1:5 |
| 53. | flubendiamide | 125:1 to 1:125 | 25:1 to 1:25 | 5:1 to 1:5 |
| 54. | chlorantraniliprole | 125:1 to 1:125 | 25:1 to 1:25 | 5:1 to 1:5 |
| | (Rynaxypyr) | | | |
| 55. | Cyazypyr | 125:1 to 1:125 | 25:1 to 1:25 | 5:1 to 1:5 |
| 56. | emamectin | 125:1 to 1:125 | 25:1 to 1:25 | 5:1 to 1:5 |
| 57. | emamectin benzoate | 125:1 to 1:125 | 25:1 to 1:25 | 5:1 to 1:5 |
| 58. | abamectin | 125:1 to 1:125 | 25:1 to 1:25 | 5:1 to 1:5 |
| 59. | ivermectin | 125:1 to 1:125 | 25:1 to 1:25 | 5:1 to 1:5 |
| 60. | milbemectin | 125:1 to 1:125 | 25:1 to 1:25 | 5:1 to 1:5 |
| 61. | lepimectin | 125:1 to 1:125 | 25:1 to 1:25 | 5:1 to 1:5 |
| 62. | tebufenpyrad | 125:1 to 1:125 | 25:1 to 1:25 | 5:1 to 1:5 |
| 63. | fenpyroximate | 125:1 to 1:125 | 25:1 to 1:25 | 5:1 to 1:5 |
| 64. | pyridaben | 125:1 to 1:125 | 25:1 to 1:25 | 5:1 to 1:5 |
| 65. | fenazaquin | 125:1 to 1:125 | 25:1 to 1:25 | 5:1 to 1:5 |
| 66. | pyrimidifen | 125:1 to 1:125 | 25:1 to 1:25 | 5:1 to 1:5 |
| 67. | tolfenpyrad | 125:1 to 1:125 | 25:1 to 1:25 | 5:1 to 1:5 |
| 68. | dicofol | 125:1 to 1:125 | 25:1 to 1:25 | 5:1 to 1:5 |
| 69. | cyenopyrafen | 125:1 to 1:125 | 25:1 to 1:25 | 5:1 to 1:5 |
| 70. | cyflumetofen | 125:1 to 1:125 | 25:1 to 1:25 | 5:1 to 1:5 |
| 71. | acequinocyl | 125:1 to 1:125 | 25:1 to 1:25 | 5:1 to 1:5 |
| 72. | fluacrypyrin | 125:1 to 1:125 | 25:1 to 1:25 | 5:1 to 1:5 |
| 73. | bifenazate | 125:1 to 1:125 | 25:1 to 1:25 | 5:1 to 1:5 |
| 74. | diafenthiuron | 125:1 to 1:125 | 25:1 to 1:25 | 5:1 to 1:5 |
| 75. | etoxazole | 125:1 to 1:125 | 25:1 to 1:25 | 5:1 to 1:5 |
| 76. | clofentezine | 125:1 to 1:125 | 25:1 to 1:25 | 5:1 to 1:5 |
| 77. | spinosad | 125:1 to 1:125 | 25:1 to 1:25 | 5:1 to 1:5 |
| 78. | triarathen | 125:1 to 1:125 | 25:1 to 1:25 | 5:1 to 1:5 |
| 79. | tetradifon | 125:1 to 1:125 | 25:1 to 1:25 | 5:1 to 1:5 |
| 80. | propargite | 125:1 to 1:125 | 25:1 to 1:25 | 5:1 to 1:5 |
| 81. | hexythiazox | 125:1 to 1:125 | 25:1 to 1:25 | 5:1 to 1:5 |
| 82. | bromopropylate | 125:1 to 1:125 | 25:1 to 1:25 | 5:1 to 1:5 |
| 83. | chinomethionat | 125:1 to 1:125 | 25:1 to 1:25 | 5:1 to 1:5 |
| 84. | amitraz | 125:1 to 1:125 | 25:1 to 1:25 | 5:1 to 1:5 |
| 85. | pyrifluquinazon | 125:1 to 1:125 | 25:1 to 1:25 | 5:1 to 1:5 |
| 86. | pymetrozine | 125:1 to 1:125 | 25:1 to 1:25 | 5:1 to 1:5 |
| 87. | flonicamid | 125:1 to 1:125 | 25:1 to 1:25 | 5:1 to 1:5 |
| 88. | pyriproxyfen | 125:1 to 1:125 | 25:1 to 1:25 | 5:1 to 1:5 |
| 89. | diofenolan | 125:1 to 1:125 | 25:1 to 1:25 | 5:1 to 1:5 |
| 90. | chlorfenapyr | 125:1 to 1:125 | 25:1 to 1:25 | 5:1 to 1:5 |
| 91. | metaflumizone | 125:1 to 1:125 | 25:1 to 1:25 | 5:1 to 1:5 |
| 92. | indoxacarb | 125:1 to 1:125 | 25:1 to 1:25 | 5:1 to 1:5 |
| 93. | chlorpyrifos | 125:1 to 1:125 | 25:1 to 1:25 | 5:1 to 1:5 |
| 94. | spirodiclofen | 125:1 to 1:125 | 25:1 to 1:25 | 5:1 to 1:5 |
| 95. | spiromesifen | 125:1 to 1:125 | 25:1 to 1:25 | 5:1 to 1:5 |
| 96. | spirotetramat | 125:1 to 1:125 | 25:1 to 1:25 | 5:1 to 1:5 |
| 97. | pyridalyl | 125:1 to 1:125 | 25:1 to 1:25 | 5:1 to 1:5 |
| 98. | spinetoram | 125:1 to 1:125 | 25:1 to 1:25 | 5:1 to 1:5 |
| 99. | acephate | 125:1 to 1:125 | 25:1 to 1:25 | 5:1 to 1:5 |
| 100. | triazophos | 125:1 to 1:125 | 25:1 to 1:25 | 5:1 to 1:5 |
| 101. | profenofos | 125:1 to 1:125 | 25:1 to 1:25 | 5:1 to 1:5 |
| 102. | fenamiphos | 125:1 to 1:125 | 25:1 to 1:25 | 5:1 to 1:5 |
| 103. | 4-{[(6-chloropyrid-3- | 125:1 to 1:125 | 25:1 to 1:25 | 5:1 to 1:5 |
| | yl)methyl](2,2- | | | |
| | difluoroethyl)amino}furan- | | | |
| | 2(5H)-one | | | |
| 104. | cadusaphos | 125:1 to 1:125 | 25:1 to 1:25 | 5:1 to 1:5 |
| 105. | carbaryl | 125:1 to 1:125 | 25:1 to 1:25 | 5:1 to 1:5 |
| 106. | carbofuran | 125:1 to 1:125 | 25:1 to 1:25 | 5:1 to 1:5 |
| 107. | ethoprophos | 125:1 to 1:125 | 25:1 to 1:25 | 5:1 to 1:5 |
| 108. | thiodicarb | 125:1 to 1:125 | 25:1 to 1:25 | 5:1 to 1:5 |
| 109. | aldicarb | 125:1 to 1:125 | 25:1 to 1:25 | 5:1 to 1:5 |
| 110. | metamidophos | 125:1 to 1:125 | 25:1 to 1:25 | 5:1 to 1:5 |
| 111. | methiocarb | 125:1 to 1:125 | 25:1 to 1:25 | 5:1 to 1:5 |
| 112. | sulfoxaflor | 125:1 to 1:125 | 25:1 to 1:25 | 5:1 to 1:5 |
| 113. | azoxystrobin | 125:1 to 1:125 | 25:1 to 1:25 | 5:1 to 1:5 |
| 114. | boscalid | 125:1 to 1:125 | 25:1 to 1:25 | 5:1 to 1:5 |
| 115. | penflufen | 125:1 to 1:125 | 25:1 to 1:25 | 5:1 to 1:5 |
| 116. | carbendazim | 125:1 to 1:125 | 25:1 to 1:25 | 5:1 to 1:5 |
| 117. | carboxin | 125:1 to 1:125 | 25:1 to 1:25 | 5:1 to 1:5 |
| 118. | fenamidone | 125:1 to 1:125 | 25:1 to 1:25 | 5:1 to 1:5 |
| 119. | fludioxonil | 125:1 to 1:125 | 25:1 to 1:25 | 5:1 to 1:5 |
| 120. | fluopicolide | 125:1 to 1:125 | 25:1 to 1:25 | 5:1 to 1:5 |
| 121. | fluoxastrobin | 125:1 to 1:125 | 25:1 to 1:25 | 5:1 to 1:5 |
| 122. | fluquinconazole | 125:1 to 1:125 | 25:1 to 1:25 | 5:1 to 1:5 |
| 123. | flutriafol | 125:1 to 1:125 | 25:1 to 1:25 | 5:1 to 1:5 |
| 124. | ipconazole | 125:1 to 1:125 | 25:1 to 1:25 | 5:1 to 1:5 |
| 125. | iprodione | 125:1 to 1:125 | 25:1 to 1:25 | 5:1 to 1:5 |
| 126. | isotianil | 125:1 to 1:125 | 25:1 to 1:25 | 5:1 to 1:5 |
| 127. | mefenoxam | 125:1 to 1:125 | 25:1 to 1:25 | 5:1 to 1:5 |
| 128. | metalaxyl | 125:1 to 1:125 | 25:1 to 1:25 | 5:1 to 1:5 |
| 129. | metominostrobin | 125:1 to 1:125 | 25:1 to 1:25 | 5:1 to 1:5 |
| 130. | pencycuron | 125:1 to 1:125 | 25:1 to 1:25 | 5:1 to 1:5 |
| 131. | prochloraz | 125:1 to 1:125 | 25:1 to 1:25 | 5:1 to 1:5 |
| 132. | prothioconazole | 125:1 to 1:125 | 25:1 to 1:25 | 5:1 to 1:5 |
| 133. | pyraclostrobin | 125:1 to 1:125 | 25:1 to 1:25 | 5:1 to 1:5 |
| 134. | pyrimethanil | 125:1 to 1:125 | 25:1 to 1:25 | 5:1 to 1:5 |
| 135. | sedaxane | 125:1 to 1:125 | 25:1 to 1:25 | 5:1 to 1:5 |
| 136. | silthiopham | 125:1 to 1:125 | 25:1 to 1:25 | 5:1 to 1:5 |
| 137. | tebuconazole | 125:1 to 1:125 | 25:1 to 1:25 | 5:1 to 1:5 |
| 138. | thiram | 125:1 to 1:125 | 25:1 to 1:25 | 5:1 to 1:5 |
| 139. | tolylfluanid | 125:1 to 1:125 | 25:1 to 1:25 | 5:1 to 1:5 |
| 140. | triadimenol | 125:1 to 1:125 | 25:1 to 1:25 | 5:1 to 1:5 |
| 141. | triazoxide | 125:1 to 1:125 | 25:1 to 1:25 | 5:1 to 1:5 |
| 142. | trifloxystrobin | 125:1 to 1:125 | 25:1 to 1:25 | 5:1 to 1:5 |
| 143. | triflumuron | 125:1 to 1:125 | 25:1 to 1:25 | 5:1 to 1:5 |
| 144. | triticonazole | 125:1 to 1:125 | 25:1 to 1:25 | 5:1 to 1:5 |

Preference is further given to those active compound combinations (Nos. 1 to 144) in which an active compound of component A is combined with the following active compounds of component B in the mixing ratios given in Table A1. These active compound combinations are listed in Table A1 below. The mixing ratios in the table are based on weight ratios. The ratio is to be understood as component A:component B.

TABLE A1

| | | | | |
|---|---|---|---|---|
| 145 | benfuracarb | 125:1 to 1:125 | 25:1 to 1:25 | 5:1 to 1:5 |
| 146 | carbosulphan | 125:1 to 1:125 | 25:1 to 1:25 | 5:1 to 1:5 |
| 147 | cartap | 125:1 to 1:125 | 25:1 to 1:25 | 5:1 to 1:5 |
| 148 | chloropicrin | 125:1 to 1:125 | 25:1 to 1:25 | 5:1 to 1:5 |
| 149 | diazinon | 125:1 to 1:125 | 25:1 to 1:25 | 5:1 to 1:5 |
| 150 | dichloropropene | 125:1 to 1:125 | 25:1 to 1:25 | 5:1 to 1:5 |
| 151 | dichlorvos | 125:1 to 1:125 | 25:1 to 1:25 | 5:1 to 1:5 |
| 152 | dimethoate | 125:1 to 1:125 | 25:1 to 1:25 | 5:1 to 1:5 |
| 153 | disulphoton | 125:1 to 1:125 | 25:1 to 1:25 | 5:1 to 1:5 |
| 154 | fenbutatin-oxide | 125:1 to 1:125 | 25:1 to 1:25 | 5:1 to 1:5 |
| 155 | fenitrothion | 125:1 to 1:125 | 25:1 to 1:25 | 5:1 to 1:5 |
| 156 | fenobucarb | 125:1 to 1:125 | 25:1 to 1:25 | 5:1 to 1:5 |
| 157 | fenoxycarb | 125:1 to 1:125 | 25:1 to 1:25 | 5:1 to 1:5 |
| 158 | fosthiazate | 125:1 to 1:125 | 25:1 to 1:25 | 5:1 to 1:5 |
| 159 | malathion | 125:1 to 1:125 | 25:1 to 1:25 | 5:1 to 1:5 |
| 160 | metaldehyde | 125:1 to 1:125 | 25:1 to 1:25 | 5:1 to 1:5 |
| 161 | metam-sodium | 125:1 to 1:125 | 25:1 to 1:25 | 5:1 to 1:5 |
| 162 | methidathion | 125:1 to 1:125 | 25:1 to 1:25 | 5:1 to 1:5 |
| 163 | methomyl | 125:1 to 1:125 | 25:1 to 1:25 | 5:1 to 1:5 |
| 164 | monocrotophos | 125:1 to 1:125 | 25:1 to 1:25 | 5:1 to 1:5 |
| 165 | monosultap | 125:1 to 1:125 | 25:1 to 1:25 | 5:1 to 1:5 |
| 166 | omethoate | 125:1 to 1:125 | 25:1 to 1:25 | 5:1 to 1:5 |
| 167 | oxamyl | 125:1 to 1:125 | 25:1 to 1:25 | 5:1 to 1:5 |
| 168 | phorate | 125:1 to 1:125 | 25:1 to 1:25 | 5:1 to 1:5 |
| 169 | phosmet | 125:1 to 1:125 | 25:1 to 1:25 | 5:1 to 1:5 |
| 170 | phoxim | 125:1 to 1:125 | 25:1 to 1:25 | 5:1 to 1:5 |
| 171 | pirimicarb | 125:1 to 1:125 | 25:1 to 1:25 | 5:1 to 1:5 |
| 172 | quinalphos | 125:1 to 1:125 | 25:1 to 1:25 | 5:1 to 1:5 |
| 173 | terbufos | 125:1 to 1:125 | 25:1 to 1:25 | 5:1 to 1:5 |
| 174 | trichlorfon | 125:1 to 1:125 | 25:1 to 1:25 | 5:1 to 1:5 |
| 175 | 1-{2-fluoro-4-methyl-5-[(2,2,2- | 125:1 to 1:125 | 25:1 to 1:25 | 5:1 to 1:5 |
| | trifluorethyl)sulphinyl]phenyl}- | | | |
| | 3-(trifluoromethyl)-1H-1,2,4- | | | |
| | triazol-5-amine | | | |
| 176 | 2-{6-[2-(5-fluoropyridin-3-yl)- | 125:1 to 1:125 | 25:1 to 1:25 | 5:1 to 1:5 |
| | 1,3-thiazol-5-yl]pyridin-2- | | | |
| | yl}pyrimidine | | | |
| 177 | 2-{6-[2-(pyridin-3-yl)-1,3- | 125:1 to 1:125 | 25:1 to 1:25 | 5:1 to 1:5 |
| | thiazol-5-yl]pyridin-2- | | | |
| | yl}pyrimidine | | | |
| 178 | 1-(3-chloropyridin-2-yl)-N-[4- | 125:1 to 1:125 | 25:1 to 1:25 | 5:1 to 1:5 |
| | cyano-2-methyl-6- | | | |
| | (methylcarbamoyl)phenyl]-3- | | | |
| | {[5-(trifluoromethyl)-1H- | | | |
| | tetrazol-1-yl]methyl}-1H- | | | |
| | pyrazole-5-carboxamide | | | |
| 179 | 1-(3-chloropyridin-2-yl)-N-[4- | 125:1 to 1:125 | 25:1 to 1:25 | 5:1 to 1:5 |
| | cyano-2-methyl-6- | | | |
| | (methylcarbamoyl)phenyl]-3- | | | |
| | {[5-(trifluoromethyl)-2H- | | | |
| | tetrazol-2-yl]methyl}-1H- | | | |
| | pyrazole-5-carboxamide | | | |
| 180 | N-[2-(tert-butylcarbamoyl)-4- | 125:1 to 1:125 | 25:1 to 1:25 | 5:1 to 1:5 |
| | cyano-6-methylphenyl]-1-(3- | | | |
| | chloropyridin-2-yl)-3-{[5- | | | |
| | (trifluoromethyl)-1H-tetrazol- | | | |
| | 1-yl]methyl}-1H-pyrazole-5- | | | |
| | carboxamide | | | |
| 181 | N-[2-(tert-butylcarbamoyl)-4- | 125:1 to 1:125 | 25:1 to 1:25 | 5:1 to 1:5 |
| | cyano-6-methylphenyl]-1-(3- | | | |
| | chloropyridin-2-yl)-3-{[5- | | | |
| | (trifluoromethyl)-2H-tetrazol- | | | |
| | 2-yl]methyl}-1H-pyrazole-5- | | | |
| | carboxamide | | | |

The active compound combinations according to the invention are highly suitable for controlling animal pests or unwanted microorganisms.

If, in the context of this description, the short form of the common name of an active compound is used, this comprises in each case all customary derivatives, such as the esters and salts, and isomers, in particular optical isomers, especially the commercially available form or forms. If the common name refers to an ester or a salt, this in each case also comprises all other customary derivatives, such as other esters and salts, the free acids and neutral compounds, and isomers, in particular optical isomers, especially the commercially available form or forms. The given chemical compound names refer to at least one of the compounds embraced by the common name, frequently to a preferred compound.

Surprisingly, the insecticidal and/or acaricidal and/or antimicrobial activity or the fungicidal activity and/or the plant-invigorating activity and/or the yield-enhancing activity of the active compound combinations according to the invention is significantly higher than the sum of the activities of the individual active compounds within components A and B. An unforeseeable true synergistic effect is present, and not just an addition of activities.

Furthermore, the compounds of the general formulae (Ia) to (Iv) can be mixed with the herbicides below. This also applies to the mixtures according to the invention, in particular those listed in Table A, which can also be mixed with the herbicides below and applied to plants or plant parts. In many cases, these mixtures with herbicides have synergistic activities.

Fruit/vegetable herbicides: atrazine, bromacil, diuron, glyphosate, linuron, metribuzin, simazine, trifluralin, fluazifop, glufosinate, halosulfuron Gowan, paraquat, propyzamide, sethoxydim, butafenacil, halosulfuron, indaziflam;
cereal herbicides: isoproturon, bromoxynil, ioxynil, phenoxies, chlorsulfuron, clodinafop, diclofop, diflufenican, fenoxaprop, florasulam, fluoroxypyr, metsulfuron, triasulfuron, flucarbazone, iodosulfuron, propoxycarbazone, picolinafen, mesosulfuron, beflubutamid, pinoxaden, amidosulfuron, thifensulfuron, tribenuron, flupyrsulfuron, sulfosulfuron, pyrasulfotole, pyroxsulam, flufenacet, tralkoxydim, pyroxasulfon;
maize herbicides: atrazine, alachlor, bromoxynil, acetochlor, dicamba, clopyralid, (S-)dimethenamid, glufosinate, glyphosate, isoxaflutoic, (S-)metolachlor, mesotrione, nicosulfuron, primisulfuron, rimsulfuron, sulcotrione, foramsulfuron, topramezone, tembotrione, saflufenacil, thiencarbazone, flufenacet, pyroxasulfon;
rice herbicides: butachlor propanil, azimsulfuron, bensulfuron, cyhalofop, daimuron, fentrazamide, imazosulfuron, mefenacet, oxaziclomefone, pyrazosulfuron, pyributicarb, quinclorac, thiobencarb, indanofan, flufenacet, fentrazamide, halosulfuron, oxaziclomefone, benzobicyclon, pyriftalid, penoxsulam, bispyribac, oxadiargyl, ethoxysulfuron, pretilachlor, mesotrione, tefuryltrione, oxadiazone, fenoxaprop, pyrimisulfan;
cotton herbicides: diuron, fluometuron, MSMA, oxyfluorfen, prometryn, trifluralin, carfentrazone, clethodim, fluazifop-butyl, glyphosate, norflurazon, pendimethalin, pyrithiobac-sodium, trifloxysulfuron, tepraloxydim, glufosinate, flumioxazin, thidiazuron;
soya bean herbicides: alachlor, bentazone, trifluralin, chlorimuron-ethyl, cloransulam-methyl, fenoxaprop, fomesafen, fluazifop, glyphosate, imanmox, imazaquin, imazethapyr, (S-)metolachlor, metribuzin, pendimethalin, tepraloxydim, glufosinate;
sugar beet herbicides: chloridazon, desmedipham, ethofumesate, phenmedipham, triallate, clopyralid, fluazifop, lenacil, metamitron, quinmerac, cycloxydim, triflusulfuron, tepraloxydim, quizalofop;
oilseed rape herbicides: clopyralid, diclofop, fluazifop, glufosinate, glyphosate, metazachlor, trifluralin, ethametsulfuron, quirunerac, quizalofop, clethodim, tepraloxydim;

Preference is given to mixtures of component A with total herbicides such as, for example glyphosate or glufosinate.

Particular preference is given to mixtures of component A with glyphosate. Particular preference is in particular given to mixtures of component A with glufosinate.

The active compound combinations according to the invention, in combination with good plant tolerance, favourable toxicity to warm-blooded animals and being tolerated well by the environment, are suitable for protecting plants and plant organs, for increasing the harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in the protection of stored products and of materials, and in the hygiene sector. They may be preferably employed as crop protection agents. They are active against normally sensitive and resistant species and also against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus spp., Aceria sheldoni, Aculops spp., Aculus spp., Amblyomma spp., Amphitetranychus vicnnensis, Argas spp., Boophilus spp., Brevipalpus spp., Bryobia practiosa, Chorioptes spp., Dermanyssus gallinae, Eotetranychus spp., Epitrimerus pyri, Eutetranychus spp., Eriophyes spp., Halotydeus destructor, Hemitarsonemus spp., Hyalomma spp., Ixodes spp., Latrodectus mactans, Metatetranychus spp., Nuphersa spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsoncmus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acalymma vittatum, Acanthoseclides obtectus, Adoretus spp., Agelastica alni, Agriotes spp., Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costclytra zcalandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Mcligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phacdon cochleariae, Phyllophaga spp., Phyllotreta spp., Popillia japonica, Premnotrypes spp., Psylliodes spp., Ptinus spp., Rhizobius ventralis, Rhizopertha dominica, Sitophilus spp., Sphenophorus spp., Sternechus spp., Symphyletes spp., Tanymecus spp., Tenebrio molitor, Tribolium spp., Trogoderma spp., Tychius spp., Xylotrcchus spp., Zabrus spp.

From the order of the Collembola; for example, Onychiurus armatus.

From the order of the Diplopoda, for example, Blaniulus guttulatus.

From the order of the Diptera, for example, Aedes spp., Agromyza spp., Anastrepha spp., Anopheles spp., Asphondylia spp., Bactrocera spp., Bibio hortulanus, Calliphora crythrocephala, Ceratitis capitata, Chironomus spp., Chrysomyia spp., Cochliomyia spp., Contarinia spp., Cordylobia anthropophaga, Culex spp., Cuterebra spp., Dacus olcae, Dasyncura spp., Delia spp., Dermatobia hominis, Drosophila spp., Echinocncmus spp., Fannia spp, Gastrophilus spp., Hydrellia spp., Hylemyia spp., Hyppobosca spp., Hypoderma spp., Liriomyza spp. Lucilia spp., Musca spp., Nezara spp., Oestrus spp., Oscinella frit, Pegomyia spp., Phorbia spp., Prodiplosis spp., Psila rosae, Rhagoletis spp., Stomoxys spp., Tabanus spp., Tannia spp., Tetanops spp., Tipula spp.

From the class of the Gastropoda, for example, Anion spp., Biomphalaria spp., Bulinus spp., Deroceras spp., Galba spp., Lymnaea spp., Oncomelania spp., Pomacea spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp, Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp, Strongyloides fuelleborni, Strongyloides stercoralis, Stronyloides spp., Taenia saginata, Tacnia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is additionally possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera, for example, Acyrthosipon spp., Acrogonia spp., Aencolamia spp., Agonoscena spp., Aleurodes spp., Aleurolobus barodensis, Alcurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginate, Cameocephala fulgida, Ceratovacuna lanigera, Cercopidae, Ceroplastes spp., Chaetosiphon fragaefolii, Chionaspis tegalensis, Chloroita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosnma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodeiphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monclliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp, Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalnsiphum spp., Saissetia spp., Scaphoides titanus, Schizaphis gratninum, Selenaspidus aniculatus, Sogata spp., Sogatella furcifera, Sogatodes spp., Stictocephala festina, Tcnalaphara malayensis, Tinocallis caryacfoliae, Tomaspis spp., Toxoptera spp., Trialeurodes spp., Trioza spp., Typhlocyba spp., Unaspis spp., Viteus vitifolii, Zygina spp.

From the order of the Hymenoptera, for example, Athalia spp., Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Acromyrmex spp., Atta spp., Comitcrmcs cumulans, Microtermes obesi, Odontotermes spp., Reticulitermes spp,

From the order of the Lepidoptera, for example, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoccia spp., Caloptilia theivora, Capua reticulana, Carpocapsa pomonella, Carposina niponcnsis, Chematobia brumata, Chilo spp., Choristoncura spp., Clysia ambiguella, Cnaphaloccrus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia kuehniella, Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homocosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malaeosoma neustria, Maraca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tccia solanivora, Thermesia gemmatalis, Tinca pellionella, Tineola bisselliella, Tortrix spp., Trichoplusia spp., Tuta absoluta, Virachola spp.

From the order of the Orthoptera, for example, Acheta domesticus, Blatta orientalis, Blattella germanica, Dichroplus spp., Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella spp.

From the order of the Thysanoptera, for example, Anaphothrips obscurus, Baliothrips biformis, Drepanothris reuteri, Enneothrips flavens, Frankliniella spp., Heliothrips spp., Hercinothrips femoralis, Rhipiphorothrips crucntatus, Scirtothrips spp., Taeniothrips cardamoni, Thrips spp.

From the order of the Thysanura, for example, Lepisma saccharina.

The phytoparasitic nematodes include, for example, Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

The present invention further relates to formulations, and application forms prepared from them, as crop protection compositions and/or pesticides, such as drench, drip and spray liquors; comprising at least one of the active compounds of the invention. The application forms may comprise further crop protection agents and/or pesticides, and/or activity-enhancing adjuvants such as penetrants, examples being vegetable oils such as, for example, rapeseed oil, sunflower oil, mineral oils such as, for example, liquid paraffins, alkyl esters of vegetable fatty acids, such as rapeseed oil or soybean oil methyl esters, or alkanol alkoxylates, and/or spreaders such as, for example, alkylsiloxanes and/or salts, examples being organic or inorganic ammonium or phosphonium salts, examples being ammonium sulphate or diammonium hydrogenphosphate, and/or retention promoters such as dioctyl sulphosuccinate or hydroxypropylguar polymers and/or humectants such as glycerol and/or fertilizers such as ammonium, potassium or phosphorus fertilizers, for example.

Examples of typical formulations include water-soluble liquids (SL), emulsifiable concentrates (EC), emulsions in water (EW), suspension concentrates (SC, SE, FS, OD), water-dispersible granules (WG), granules (GR) and capsule concentrates (CS); these and other possible types of formulation are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations may comprise active agrochemical compounds other than one or more active compounds of the invention.

The formulations or application forms in question preferably comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect. Examples of adjuvants are agents which promote the retention, spreading, attachment to the leaf surface, or penetration.

These formulations are produced in a known manner, for example by mixing the active compounds with auxiliaries, such as extenders, solvents and/or solid carriers and/or further auxiliaries such as surfactants. The formulations are prepared either in suitable plants or else before or during the application.

The auxiliaries used may be those substances which are suitable for imparting particular properties, such as certain physical, technical and/or biological properties, to the formulation of the active compound or to the application forms prepared from these formulations (for example ready-to-use crop protection compositions, such as spray liquors or seed dressings).

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

In principle it is possible to use all suitable solvents. Suitable solvents are, for example, aromatic hydrocarbons, such as xylem, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, mineral oil fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

All suitable carriers may in principle be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonie acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed oil or soybean oil methyl esters, fatty amine alkoxylates such as tallowamine ethoxylate (15), or ammonium and/or phosphonium salts such as ammonium sulphate or diammonium hydrogen phosphate, for example.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Plant parts are to be understood as meaning all above-ground and below-ground parts and organs of plants, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

Treatment according to the invention of the plants and plant parts with the active compound combinations is carried out directly or by allowing the combinations to act on their surroundings, environment or storage space by the customary treatment methods, for example by immersion, spraying, evaporation, pouring, fogging, scattering, painting on and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention.

Depending on the plant species or plant cultivars, their location and growth conditions (soils, climate, vegetation period, nutrition), the treatment according to the invention may also result in superadditive (“synergistic”) effects. Thus possible are, for example, reduced application rates and/or a widening of the activity spectrum and/or an increase of the activity of the compounds and compositions usable according to the invention, better plant growth, increased tolerance to high or low temperatures, increased tolerance to drought or to water or soil salt content, increased flowering, easier harvesting, accelerated maturation, higher harvest yields, higher quality and/or higher nutritional value of the harvested products, increased storability and/or processability of the harvested products, which exceed the effects which are actually, to be expected.

The preferred transgenic plants or plant cultivars (i.e. those obtained by genetic engineering) which are to be treated according to the invention include all plants which, in the genetic modification, received genetic material which imparts particular advantageous useful properties (“traits”) to these plants. Examples of such properties are better plant growth, increased tolerance to high or low temperatures, increased tolerance to drought or to water or soil salt content, increased flowering, easier harvesting, accelerated maturation, higher harvest yields, higher quality and/or a higher nutritional value of the harvested products, better storability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are emphasized are in particular increased defence of the plants against insects by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinothricin (for example the “PAT” gene). The genes which impart the desired traits in question can also be present in combinations with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link® (tolerance to phosphinothricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plants will be developed and/or marketed in the future.

The plants listed can be treated according to the invention in a particularly advantageous manner with the active compound mixture according to the invention. The preferred ranges stated above for the active compound combinations also apply to the treatment of these plants. Particular emphasis is given to the treatment of plants with the active compound combinations specifically mentioned in the present text.

The good action of the active compound combinations according to the invention can be seen from the examples which follow. While the individual active compounds show weaknesses in their action, the combinations show an action which exceeds a simple sum of actions.

A synergistic effect is always present when the action of the active compound combinations exceeds the total of the actions of the active compounds when applied individually.

The active compound combinations according to the invention have increased microbicidal activity (compared to the microbially active compound(s) within component B) and can be used for controlling unwanted microorganisms such as fungi and bacteria in crop protection and in the protection of materials.

Fungicides can be used in crop protection for controlling Plasmodiophoromycetes, Oomycetes, Chytridiomycetes, Zygomycetes, Ascomycetes, Basidiomycetes and Deuteromycetes.

Bactericides can be used in crop protection for controlling Pseudomonadaceae, Rhizobiaccae, Enterobacteriaceae, Corynebacteriaceae and Streptomycetaceae.

Some pathogens causing fungal and bacterial diseases which come under the generic names listed above may be mentioned as examples, but not by way of limitation:

Diseases caused by powdery mildew pathogens, such as, for example,

Blumeria species such as, for example, Blumeria graminis;
Podosphaera species such as, for example, Podosphaera leucotricha;
Sphaerotheca species such as, for example, Sphaerotheca fuliginea;
Uncinula species such as, for example, Uncinula necator;

Diseases caused by rust disease pathogens, such as, for example,

Gymnosporangium species such as, for example, Gymnosporangium sabinae
Hemileia species such as, for example, Hemileia vastatrix;
Phakopsora species such as, for example, Phakopsora pachyrhizi and Phakopsora meibomiae;
Puccinia species such as, for example, Puccinia recondita;
Uromyces species such as, for example, Uromyces appendiculatus;

Diseases caused by pathogens from the group of the Oomycetes, such as, for example,

Bremia species such as, for example, Bremia lactucae;
Peronospora species such as, for example, Peronospora pisi or P. brassicae;
Phytophthora species such as, for example, Phytophthora infestans;
Plasmopara species such as, for example, Plasmopara viticola;
Pseudoperonospora species such as, for example, Pseudoperonospora humuli or Pseudoperonospora cubensis;
Pythium species such as, for example, Pythium ultimum;

Leaf blotch diseases and leaf wilt diseases caused, for example, by

Alternaria species such as, for example, Alternaria solani;
Cercospora species such as, for example, Cercospora beticola;
Cladosporium species such as, for example, Cladosporium cucumerinum;
Cochliobolus species such as, for example, Cochliobolus sativus
(conidial form: Drechslera, syn: Helminthosporium);
Colletotrichum species such as, for example, Colletotrichum lindemuthanium;
Cycloconium species such as, for example, Cycloconium oleaginum;
Diaporthe species such as, for example, Diaporthe citri;
Elsinoe species such as for example, Elsinoe fawcettii;
Gloeosporium species such as, for example, Gloeosporium laeticolor;
Glomerella species such as, for example, Glomerella cingulata; Guignardia species such as, for example, Guignardia bidwelli;
Leptosphaeria species such as, for example, Leptosphaeria macularis;
Magnaporthe species such as, for example, Magnaporthe grisea;
Mycosphaerella species such as, for example, Mycosphaerella graminicola and Mycosphaerella fijiensis;
Phaeosphaeria species such as, for example, Phaeosphaeria nodorum;
Pyrenophora species such as, for example, Pyrcnophora teres;
Ramularia species such as, for example, Ramularia collo-cygni;
Rhynchosporium species such as, for example, Rhynchosporium secalis;
Septoria species such as, for example, Septoria apii;
Typhula species such as, for example, Typhula incarnata;
Venturia species such as, for example, Venturia inaequalis;

Root and stem diseases caused, for example, by

Corticium species such as, for example, Corticium graminearum;
Fusarium species such as, for example, Fusarium oxysporum;
Gaeumannomyces species such as, for example, Gaeumannomyces graminis;
Rhizoctonia species such as, for example, Rhizoctonia solani;
Tapesia species such as for example, Tapesia acuformis;
Thielaviopsis species such as, for example, Thielaviopsis basicola;

Ear and panicle diseases (including maize cobs) caused, for example, by

Alternaria species such as, for example, Alternaria spp.;
Aspergillus species such as, for example, Aspergillus flavus;
Cladosporium species such as, for example, Cladosporium eladosporioides;
Claviceps species such as, for example, Claviceps purpurea;
Fusarium species such as, for example, Fusarium culmorum;
Gibberella species such as, for example, Gibberella zeae;
Monographella species such as, for example, Monographella nivalis;

Diseases caused by smut fungi, such as, for example,

Sphacelotheca species such as, for example, Sphacelotheca reiliana;
Tilletia species such as, for example, Tilletia caries;
Urocystis species such as, for example, Urocystis occulta;
Ustilago species such as, for example, Ustilago nuda;

Fruit rot caused, for example, by

Aspergillus species such as, for example, Aspergillus flavus;
Botrytis species such as, for example, Botrytis cinema;
Penicillium species such as, for example, Penicillium expansum and Penicillium purpurogenum;
Sclerotinia species such as, for example, Sclerotinia sclerotiorum;
Verticilium species such as, for example, Verticilium alboatrum;

Seed- and soil-borne rot and wilt diseases, and also diseases of seedlings, caused, for example, by

Fusarium species such as, for example, Fusarium culmorum;
Phytophthora species such as, for example, Phytophthora cactorum;
Pythium species such as, for example, Pythium ultimum;
Rhizoctonia species such as, for example, Rhizoctonia solani;
Sclerotium species such as, for example, Sclerotium rolfsii;

Cancerous diseases, galls and witches' broom caused, for example, by

Nectria species such as, for example, Nectria galligena;

Wilt diseases caused, for example, by

Monilinia species such as for example, Monilinia laxa;

Deformations of leaves, flowers; and fruits caused, for example, by

Taphrina species such as, for example, Taphrina deformans;

Degenerative diseases of woody plants caused, for example, by

Esca species such as, for example, Phaeomoniella chlamydospora and Phaeoacremonium aleophilum and Fomitiporia mediterranea;

Diseases of flowers and seeds caused, for example, by

Botrytis species such as, for example, Botrytis cinerea;

Diseases of plant tubers caused, for example, by

Rhizoctonia species such as, for example, Rhizoctonia solani;
Helminthosporium species such as, for example, Helminthosporium solani;

Diseases caused by bacterial pathogens, such as, for example,

Xanthomonas species such as, for example, Xanthomonas campestris pv. oryzae;
Pseudomonas species such as, for example, Pseudomonas syringae pv. lachrymans;
Erwinia species such as, for example, Erwinia amylovora;

Preference is given to being able to control the following diseases of soya beans: fungal diseases on leaves, stems, pods and seeds caused, for example, by

alternaria leaf spot (Alternaria spec. atrans tenuissima), anthracnose (Colletotrichum glocosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphacrulina leaf spot (Leptosphaerulina trifolii), phyllostica leaf spot (Phyllostica sojaccola), pod and stem blight (Phomopsis sojae), powdery mildew (Microsphaera diffusa), pyrenochaeta leaf spot (Pyrenochaea glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola).

Fungal diseases on roots and the stem base caused, for example, by

black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phascolorum var. caulivora), phytophthora rot (Phytophthora megasperma), brown stem rot (Phialophora gregata), pythium rot (Pythium aphanidermaturn, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

### Use Examples

According to S. R. Colby, Weeds 15 (1967), 20-22, the expected action for a given combination of two active compounds can be calculated as follows:

### If

X is the kill rate, expressed in % of the untreated control, when employing active compound A at an application rate of m g/ha or in a concentration of m ppm,
Y is the kill rate, expressed in % of the untreated control, when employing active compound B at an application rate of n g/ha or in a concentration of n ppm and
E is the kill rate, expressed in % of the untreated control, when employing active compounds A and B at application rates of m and n g/ha or in a concentration of m and n ppm,
   then

$$E = X + Y - \frac{X \cdot Y}{100}$$

If the actual kill rate exceeds the calculated value, the killing action of the combination is superadditive, i.e. a synergistic effect is present. In this case, the actually observed kill rate must exceed the value calculated using the above formula for the expected kill rate (E).

1. Active compound combination, comprising a component A consisting of an active compound according to any of the general formulae (Ia) to (Iv) 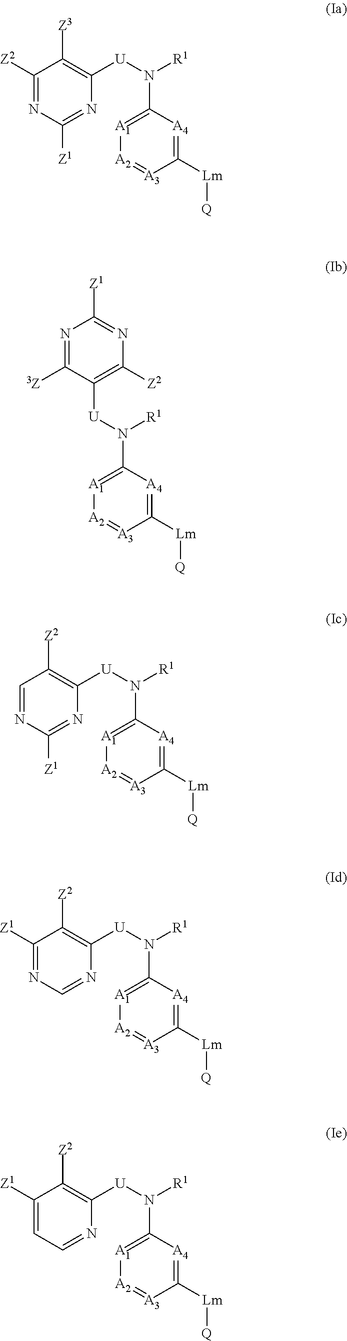 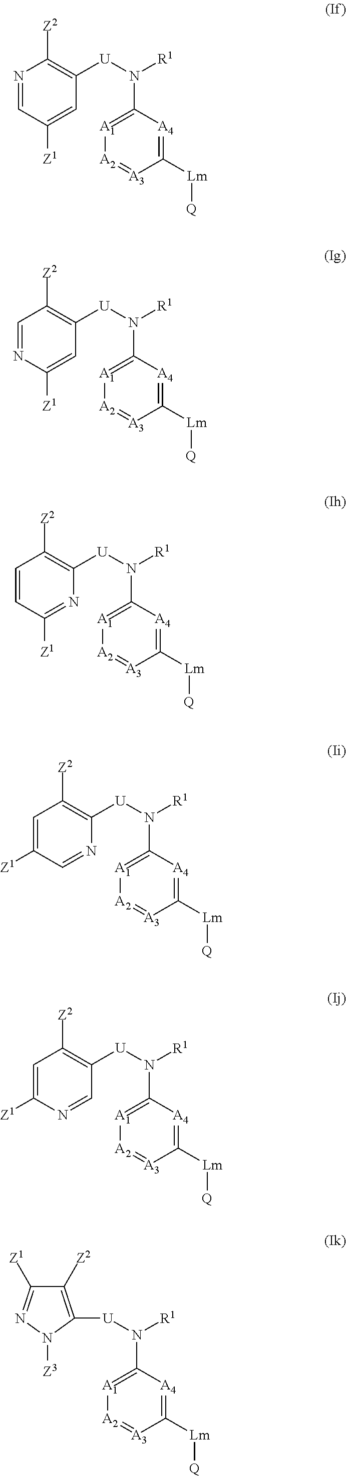 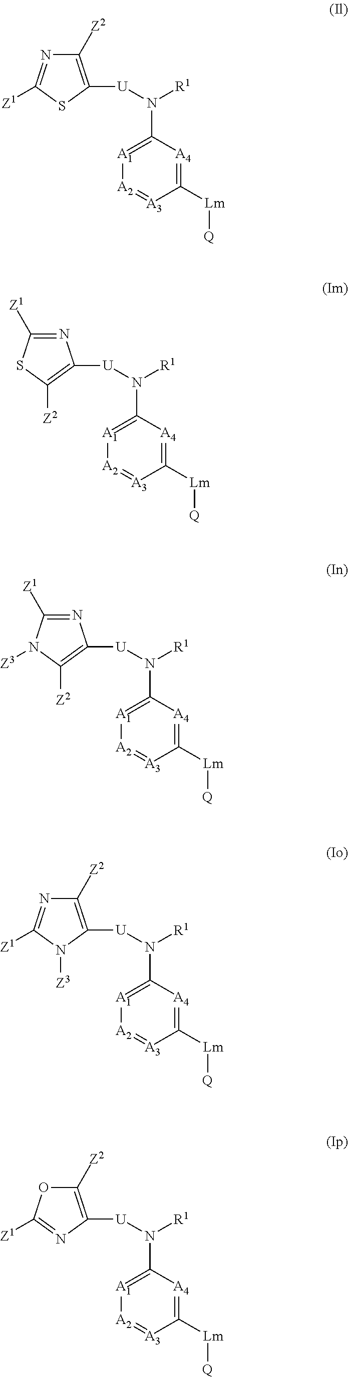 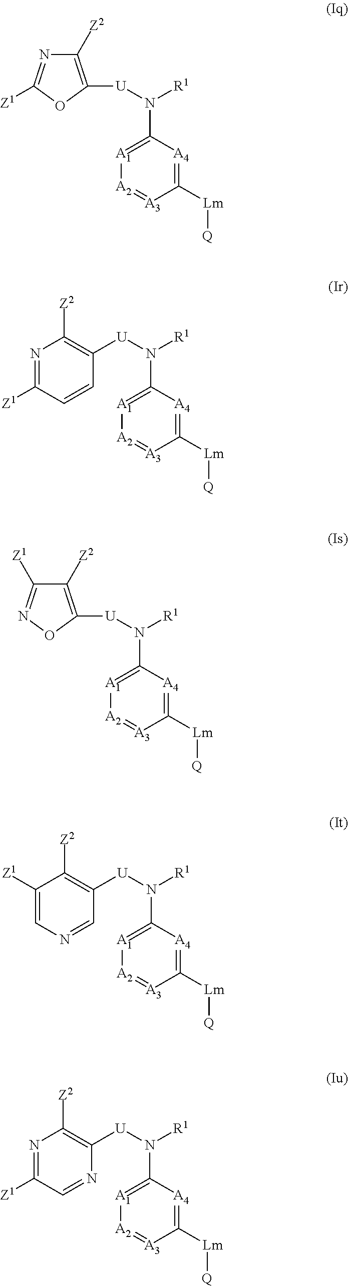 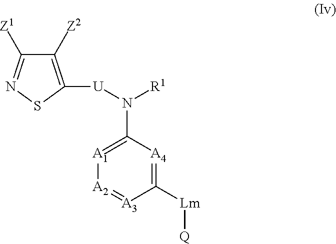
in which
R¹ represents hydrogen or the optionally substituted groupings C₁-C₆-alkyl, C₂-C₆-alkenyl, C₂-C₆-alkynyl, C₃-C₇-cycloalkyl, C₁-C₆-alkylcarbonyl, C₁-C₆-alkoxy-carbonyl, cyano-C₁-C₂-alkyl, aryl-(C₁-C₃)-alkyl, heteroaryl-(C₁-C₃)-alkyl;
A₁ represents CR² or nitrogen,
A₂ represents CR³ or nitrogen,
A₃ represents CR⁴ or nitrogen and
A₄ represents CR⁵ or nitrogen, where at most three of the chemical groupings A₁ to A₄ simultaneously represent nitrogen, and where
R², R³, R⁴ and R⁵ independently of one another represent hydrogen, halogen, CN, NO₂, optionally substituted C₁-C₆-alkyl, C₁-C₆-haloalkyl, C₃-C₆-cycloalkyl, C₃-C₆-halo-cycloalkyl, C₁-C₆-alkoxy, C₁-C₆-haloalkoxy, C₁-C₆-allylthio, C₁-C₆-haloalkylthio, C₁-C₆-alkylsulphinyl, C₁-C₆-haloalkylsulphinyl, C₁-C₆-alkylsulphonyl, C₁-C₆-halo-alkylsulphonyl, N—C₂-C₇-alkylaminocarbonyl, N—C₂-C₇-cycloalkylaminocarbonyl,
if none of the groupings A₂ and A₃ represents nitrogen, R³ and R⁴ together with the carbon atom to which they are attached may form a 5- or 6-membered ring which contains 0, 1 or 2 nitrogen atoms and/or 0 or 1 oxygen atom and/or 0 or 1 sulphur atom, or
if none of the groupings A₁ and A₂ represents nitrogen, R² and R³ together with the carbon atom to which they are attached may form a 6-membered ring which contains 0, 1 or 2 nitrogen atoms;
U represents C(═W), SO or SO₂;
W represents oxygen or sulphur;
L represents a bivalent chemical grouping selected from among the groupings —CH₂NHC(═W)—, —CH₂NR⁶C(═W)—, —C(═W)NH, —C(═W)NR⁶, —NH(C═W)NH—, —NH(C═W)NR⁶—, —NR⁶(C═W)NH—, —NR⁶(═W)NR⁶—, —C(═W)—, —C(═W)O—, —C(═W)OCH₂C(═W)—, —C(═W)OCH₂C(═W)NR⁶—, —C(═W)OCH₂C(═W)NHC(═W)NH—, —C(═W)OCH₂C(═W)NH—, —O—, —S(O)ₚ—, and —CH₂—S(O)ₚ—, —SO(═N—CN)— and —S(═N—CN)—, —C(═W)NHSO₂—, where
p may assume the value 0, 1 or 2 and
R⁶ represents hydrogen, C₁-C₆-alkyl, aryl(C₁-C₃)-alkyl, heteroaryl(C₁-C₃)-alkyl, C₂-C₇-alkylcarbonyl, C₂-C₇-alkoxycarbonyl;
m may assume the value 0 or 1;
Q represents hydrogen or the optionally substituted groupings C₁-C₆-alkyl, C₂-C₆-alkenyl, C₂-C₆-alkynyl, C₃-C₆-cycloalkyl, cyano-C₁-C₂-alkyl, C₁-C₅-hetero-cycloalkyl, C₁-C₄-alkoxy, C₄-C₇-alkylcycloalkyl, C₄-C₇-cycloalkylalkyl, C₂-C₇-alkylcarbonyl, C₁-C₆-alkylaldehyde, C₁-C₆-hydroxyallyl, C₂-C₇-alkoxycarbonyl, C₁-C₆-haloalkyl, cyano, aryl-(C₁-C₃)-alkyl, heteroaryl-(C₁-C₃)-alkyl, or represents a grouping NR⁶R⁸, where
R⁸ is selected from the group consisting of hydrogen, C₁-C₆-alkyl, C₂-C₆-alkenyl, C₂-C₆-alkynyl, C₃-C₆-cycloalkyl, C₄-C₇-alkylcycloalkyl and C₄-C₇-cycloalkylalkyl;
Z represents hydrogen, chlorine, bromine, iodine, cyano, nitro or the optionally substituted groupings C₁-C₄-alkyl, C₁-C₄-alkenyl, C₁-C₄-alkynyl, C₁-C₄-haloalkyl, C₃-C₆-cycloalkyl, C₃-C₆-halocycloalkyl, C₁-C₄-alkoxy, C₁-C₄-haloalkoxy, C₁-C₄-alkylthio, C₁-C₄-haloalkylthio, C₁-C₄-haloalkylsulphinyl, C₁-C₄-alkylsulphonyl, C₁-C₄-haloalkylsulphonyl, N,N-di-(C₁-C₄)alkylamino, and optionally R¹⁸-substituted phenyl and pyridinyl;
R¹⁸ is selected from the group consisting of halogen, —OH, —NH₂, —COOH, —CN, —NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulphinyl, C₁-C₄-haloalkylsulphinyl, C₁-C₄-alkylsulphonyl, C₁-C₄-haloalkylsulphonyl, C₁-C₄-alkylamino, N,N-di-(C₁-C₄)alkylamino, C₁-C₄-alkylcarbonyl, C₁-C₄-alkoxycarbonyl, C₁-C₄-alkylaminocarbonyl and N,N-di-(C₁-C₄)alkylaminocarbonyl;
furthermore
L, Q and R⁴ together with the carbon atoms to which they are attached may form an optionally substituted 5- or 6-membered ring which optionally contains 0, 1 or 2 nitrogen atoms and/or 0 or 1 oxygen atom and/or 0 or 1 sulphur atom;
and a component B selected from one of the groups (I-1) to (I-27) and (F-1) to (F-14) (I-1) Acetylcholinesterase (AChE) inhibitors, such as, for example,
carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
bioallethrin-S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers], esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer], prallethrin, profluthrin, pyrethrins (pyrethrum), resmethrin, RU 15525, silafluofen, tefluthrin, tetramethrin [(1R)-isomers], tralomethrin, transfluthrin and ZXI 8901; or
DDT; or methoxychlor.
(I-4) Nicotinergic acetylcholine receptor agonists, such as, for example, neonicotinoids, for example acetamiprid, clothianidin, dinotefuran, imidacloprid, imidaclothiz, nitenpyram, thiacloprid, thiamethoxam; or nicotine.
(I-5) Allosteric acetylcholine receptor modulators (agonists), such as, for example, spinosyns, for example spinetoram and spinosad.
(I-6) Chloride channel activators, such as, for example, avermectins/milbemycins, for example abamectin, emamectin benzoate, lepimectin and milbemectin.
(I-7) Juvenile hormone analogues, for example hydroprene, kinoprene, methoprene; or fenoxycarb; pyriproxyfen.
(I-8) Active compounds with unknown or non-specific mechanisms of action, such as, for example, fumigants, for example methyl bromide and other alkyl halides; or chloropicrin; sulphuryl fluoride; borax; tartar emetic.
(I-9) Selective antifeedants, for example pymetrozine; or flonicamid
(I-10) Mite growth inhibitors, for example clofentezine, diflovidazin, hexythiazox, etoxazole.
(I-11) Microbial disruptors of the insect gut membrane, such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1.
(I-12) Oxidative phosphorylation inhibitors, ATP disruptors, such as, for example, diafenthiuron; or
organotin compounds, for example azocyclotin, cyhexatin, fenbutatin oxide; or propargite; tetradifon.
(I-13) Oxidative phosphorylation decouplers acting by interrupting the H proton gradient, such as, for example, chlorfenapyr and DNOC.
(I-14) Nicotinergic acetylcholine receptor antagonists, such as, for example, bensultap, cartap (hydrochloride), thiocylam, and thiosultap (sodium).
(I-15) Chitin biosynthesis inhibitors, type 0, such as, for example, benzoylureas, for example bistrifluoron, chlorfluazuron, diflubenzuron, flucycloxuron, flufenoxuron, hexaflumuron, lufenuron, novaluron, noviflumuron, teflubenzuron and triflumuron.
(I-16) Chitin biosynthesis inhibitors, type 1, such as, for example, buprofezin.
(I-17) Moulting disruptors, such as, for example, cyromazine.
(I-18) Ecdysone agonists/disruptors, such as, for example, diacylhydrazines, for example chromafenozide, halofenozide, methoxyfenozide and tebufenozide.
(I-19) Octopaminergic agonists, such as, for example, amitraz.
(I-20) Complex-III electron transport inhibitors, such as, for example, hydramethylnon;
acequinocyl; fluacrypyrim.
(I-21) Complex-I electron transport inhibitors, for example from the group of the METI acaricides, for example fenazaquin, fenpyroximate, pyrimidifen, pyridaben, tebufenpyrad, tolfenpyrad; or rotenone (derris).
(I-22) Voltage-dependent sodium channel blockers, for example indoxacarb; metaflumizone.
(I-23) Inhibitors of acetyl-CoA carboxylase, such as, for example, tetronic acid derivatives, for example spirodiclofen and spiromesifen; or tetramic acid derivatives, for example spirotetramat.
(I-24) Complex-IV electron transport inhibitors, such as, for example, phosphines, for example aluminium phosphide, calcium phosphide, phosphine, zinc phosphide; or cyanide.
(I-25) Complex-II electron transport inhibitors, such as, for example, cyenopyrafen.
(I-26) Ryanodine receptor effectors, such as, for example, diamides, for example flubendiamide, chlorantraniliprole (Rynaxypyr), cyantraniliprole (Cyazypyr) and also 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934) or methyl 2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (known from WO2007/043677).
(I-27) Further active compounds with unknown mechanism of action, such as, for example, azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulphonyl]-1,3-thiazole), flufenerim, pyridalyl and pyrifluquinazon; and also products based on Bacillus firmus (I-1582, BioNeem, Votivo) and also the known active compounds below 4-{[(6-bromopyrid-3-yl)methyl](2-fluoroethyl)amino}furan-2(5H)-one (known from WO 2007/115644), 4-{[(6-fluoro-pyrid-3-yl)methyl](2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclo-propyl)amino}furan-2(5H)-one (known from WO 2007/115643), 4-{[(6-chloropyrid-3-yl)methyl](cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), [(6-chloropyridin-3-yl)methyl](methyl)oxido-λ⁴-sulphanylidenecyanamide (known from WO 2007/149134), [1-(6-chloropyridin-3-yl)ethyl](methyl)oxido-λ⁴-sulphanylidenecyanamide (known from WO 2007/149134) and its diastereomers (A) and (B) 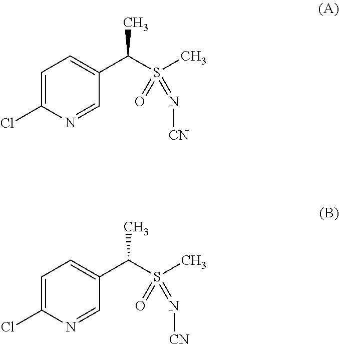
(also known from WO 2007/149134), [(6-trifluoromethylpyridin-3-yl)methyl](methyl)oxido-λ⁴-sulphanylidenecyanamide (known from WO 2007/095229), sulfoxaflor (also known from WO 2007/149134), 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911), 1-[2-fluoro-4-methyl-5-[(2,2,2-trifluoroethyl)sulphinyl]phenyl]-3-(trifluoromethyl)-1H-1,2,4-triazole-5-amine (known from WO 2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO 2006/129714), 2-cyano-3-(difluoromethoxy)-N-ethylbenzenesulphonamide (known from WO2005/035486), N-[1-(2,3-dimethylphenyl)-2-(3,5-dimethylphenyl)ethyl]-4,5-dihydro-2-thiazoleamine (known from WO2008/104503).
(F-1) Nucleic acid synthesis inhibitors, such as, for example, benalaxyl, benalaxyl-M, bupirimate, clozylacon, dimethirimol, ethirimol, furalaxyl, hymexazol, metalaxyl, metalaxyl-M, ofurace, oxadixyl and oxolinic acid.
(F-2) Mitosis and cell division inhibitors, such as, for example, benomyl, carbendazim, chlorfenazole, diethofencarb, ethaboxam, fuberidazole, pencycuron, thiabendazole, thiophanate, thiophanate-methyl and zoxamide.
(F-3) Respiration inhibitors (respiratory chain inhibitors), such as, for example, diflumetorim as inhibitor at complex I of the respiratory chain; bixafen, boscalid, carboxin, fenfuram, flutolanil, fluopyram, furametpyr, furmecyclox, isopyrazam (mixture of the syn-epimeric racemate 1RS,4SR,9RS and the anti-epimeric racemate 1RS,4SR,9SR), isopyrazam (syn-epimeric racemate 1RS,4SR,9RS), isopyrazam (syn-epimeric enantiomer 1R,4S,9R), isopyrazam (syn-epimeric enantiomer 1S,4R,9S), isopyrazam (anti-epimeric racemate 1RS,4SR,9SR), isopyrazam (anti-epimeric enantiomer 1R,4S,9S), isopyrazam (anti-epimeric enantiomer 1S,4R,9R),
mepronil, oxycarboxin, penflufen, penthiopyrad, sedaxane, thifluzamide as inhibitors at complex II of the respiratory chain; amisulbrom, azoxystrobin, cyazofamid, dimoxystrobin, enestroburin, famoxadone, fenamidone, fluoxastrobin, kresoxim-methyl, metominostrobin, orysastrobin, picoxystrobin, pyraclostrobin, pyraoxystrobin, pyrametostrobin, pyribencarb, trifloxystrobin as inhibitors at complex III of the respiratory chain.
(F-4) Decouplers, such as, for example, binapacryl, dinocap, fluazinam and meptyldinocap.
(F-5) ATP production inhibitors, such as, for example, fentin acetate, fentin chloride, fentin hydroxide and silthiofam.
(F-6) Amino acid and protein biosynthesis inhibitors, such as, for example, andoprim, blasticidin-S, cyprodinil, kasugamycin, kasugamycin hydrochloride hydrate, mepanipyrim and pyrimethanil.
(F-7) Signal transduction inhibitors, such as, for example, fenpiclonil, fludioxonil and quinoxyfen.
(F-8) Lipid and membrane synthesis inhibitors, such as, for example, biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl and vinclozolin.
(F-9) Ergosterol biosynthesis inhibitors, such as, for example, aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidole, flusilazole, flutriafol, furconazole, furconazole-cis, hexaconazole, imazalil, imazalil sulphate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafin, tetraconazole, triadimefon, triadimenol, tridemorph, triflumizole, triforin, triticonazole, uniconazole, viniconazole and voriconazole.
(F-10) Cell wall synthesis inhibitors, such as, for example, benthiavalicarb, dimethomorph, flumorph, iprovalicarb, mandipropamide, polyoxins, polyoxorim, prothiocarb, validamycin A and valefenalate.
(F-11) Melanin biosynthesis inhibitors, such as, for example, carpropamid, diclocymet, fenoxanil, fthalide, pyroquilon and tricyclazole.
(F-12) Resistance inductors such as, for example, acibenzolar-5-methyl, probenazole and tiadinil.
(F-13) Compounds with multisite activity such as, for example, Bordeaux mixture, captafol, captan, chlorothalonil, copper naphthenate, copper oxide, copper oxychloride, copper preparations such as copper hydroxide, copper sulphate, dichlofluanid, dithianone, dodine and its free base, ferbam, fluorofolpet, folpet, guazatine, guazatine acetate, iminoctadine, iminoctadine albesilate, iminoctadine triacetate, mancopper, mancozeb, maneb, metiram, zinc metiram, copper oxine, propamidin, propineb, sulphur and sulphur preparations such as, for example, calcium polysulphide, thiram, tolylfluanid, zineb and ziram.
(F-14) Other compounds such as, for example, 2,3-dibutyl-6-chlorothieno[2,3-d]pyrimidin-4(3H)-one, ethyl (2Z)-3-amino-2-cyano-3-phenylprop-2-enoate, N-[2-(1,3-dimethylbutyl)phenyl]-5-fluoro-1,3-dimethyl-1H-pyrazole-4-carboxamide, 3-(difluoromethyl)-1-methyl-N-(3′,4′,5′-trifluorobiphenyl-2-yl)-1H-pyrazole-4-carboxamide, 3-(difluoromethyl)-N-[4-fluoro-2-(1,1,2,3,3,3-hexafluoropropoxy)-phenyl]-1-methyl-1H-pyrazole-4-carboxamide, (2E)-2-(2-{[6-(3-chloro-2-methyl-phenoxy)-5-fluoropyrimidin-4-yl]oxy}phenyl)-2-(methoxyimino)-N-methyl-ethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoro-methyl)phenyl]ethylidene}amino)oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]-ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylic acid, N-ethyl-N-methyl-N′-{2-methyl-5-(trifluoromethyl)-4-[3-(trimethyl-silyl)propoxy]phenyl}imidoformamide, N′-{5-(difluoromethyl)-2-methyl-4-[3-(trimethylsilyl)propoxy]phenyl}-N-ethyl-N-methylimidoformamide, O-{1-[(4-methoxyphenoxy)methyl]-2,2-dimethylpropyl}1H-imidazole-1-carbothioate, N-[2-(4-{[3-(4-chlorophenyl)prop-2-yn-1-yl]oxy}-3-methoxyphenyl)ethyl]-N²-(methyl-sulphonyl)valinamide, 5-chloro-7-(4-methylpiperidin-1-yl)-6-(2,4,6-trifluoro-phenyl)[1,2,4]triazolo[1,5-a]pyrimidine, 5-amino-1,3,4-thiadiazole-2-thiol, propamocarb-fosetyl, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulphonyl)pyridine, 2-butoxy-6-iodo-3-propyl-4H-chromen-4-one, 2-phenyl-phenol and its salts, 3-(difluoromethyl)-1-methyl-N-[2-(1,1,2,2-tetrafluoroethoxy)phenyl]-1H-pyrazole-4-carboxamide, 3,4,5-trichloropyridin-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 8-hydroxyquinoline, 8-hydroxyquinoline sulphate, tebufloquin, 5-methyl-6-octyl-3,7-dihydro[1,2,4]triazolo[1,5-a]pyrimidine-7-amine, 5-ethyl-6-octyl-3,7-dihydro[1,2,4]triazolo[1,5-a]pyrimidine-7-amine, ametoctradin, benthiazole, bethoxazin, capsimycin, carvone, chinomethionat, chloroneb, cufraneb, cyflufenamid, cymoxanil, cyprosulfamide, dazomet, debacarb, dichlorophen, diclomezin, dicloran, difenzoquat, difenzoquat methylsulphate, diphenylamine, ecomat, ferimzone, flumetover, fluopicolid, fluoroimide, flusulfamide, flutianil, fosetyl-aluminium, fosetyl-calcium, fosetyl-sodium, hexachlorobenzene, irumamycin, isotianil, methasulfocarb, methyl (2E)-2-{2-[({cyclopropyl[(4-methoxy-phenyl)imino]methyl}thio)methyl]phenyl}-3-methoxyacrylate, methyl isothiocyanate, metrafenon, (5-chloro-2-methoxy-4-methylpyridin-3-yl)(2,3,4-trimethoxy-6-methyl-phenyl)methanone, mildiomycin, tolnifanid, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-difluorophenyl]methyl}-2-phenylacetamide, natamycin, nickel dimethyldithiocarbamate, nitrothal-isopropyl, octhilinone, oxamocarb, oxyfenthiin, pentachlorophenol and its salts, phenazin-1-carboxylic acid, phenothrin, phosphoric acid and its salts, propamocarb fosetylate, propanosine-sodium, proquinazid, pyrrolnitrin, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N-prop-2-yn-1-ylthiophene-2-sulphonohydrazide, zarilamid, N-methyl-2-(1-{[5-methyl-3-(trifluoromethyl)-1H-pyrazol-1-yl]acetyl}piperidin-4-yl)-N-[(1R)-1,2,3,4-tetrahydro-naphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, 3-(difluoromethyl)-N-[4-fluoro-2-(1,1,2,3,3,3-hexafluoropropoxy)phenyl]-1-methyl-1H-pyrazole-4-carboxamide and pentyl {6-[({[(1-methyl-1H-tetrazol-5-yl)(phenyl)methylidene]amino}oxy)-methyl]pyridin-2-yl}carbamate.

2. Active compound combinations according to claim 1 where component A is selected from (Ib), (Ie), (Ii), (Ik), (Ir).

3. Active compound combinations according to claim 1 where in component A the radicals have the following meanings:
R¹ represents hydrogen, methyl, ethyl, n-propyl, isopropyl, n-butyl, 2-butynyl, isobutyl, sec-butyl, tert-butyl, methoxymethyl, ethoxymethyl, propoxymethyl, methylcarbonyl, ethylcarbonyl, n-propylcarbonyl, allyl, propargyl, isopropylcarbonyl, sec-butylcarbonyl, tert-butylcarbonyl, methoxycarbonyl, ethoxycarbonyl, n-propoxycarbonyl, isopropoxycarbonyl, sec-butoxycarbonyl, tert-butoxycarbonyl, cyanomethyl, 2-cyanoethyl;
A₁ represents CR² or nitrogen,
A₂ represents CR³ or nitrogen,
A₃ represents CR⁴ or nitrogen and
A₄ represents CR⁵ or nitrogen, where at most three of the chemical groupings A₁ to A₄ simultaneously represent nitrogen, and where
R² and R⁵ independently of one another represent hydrogen, methyl, fluorine and chlorine and
R³ and R⁴ independently of one another represent hydrogen, fluorine, chlorine, bromine, CN, NO₂, methyl, ethyl, fluoromethyl, difluoromethyl, trifluoromethyl, 2,2,2-trifluoroethyl, methoxy, ethoxy, n-propoxy, 1-methylethoxy, fluoromethoxy, difluoromethoxy, chlorodifluoromethoxy, dichlorofluoromethoxy, trifluoromethoxy, 2,2,2-trifluoroethoxy, 2-chloro-2,2-difluoroethoxy, pentafluoroethoxy, methylsulphonyl, methylsulphinyl, trifluoromethylsulphonyl, trifluoromethylsulphinyl or N-cyclopropylaminocarbonyl; where
U represents C(═W), SO₂,
W represents oxygen,
L represents a bivalent chemical grouping selected from among the groupings —C(═O)NH, —C(═O)NR⁶, —C(═O)O—, —C(═O)OCH₂C(═O)—, —C(═O)OCH₂C(═O)NR⁶—, —C(═O)OCH₂C(═O)NHC(═O)NH—, —C(═O)OCH₂C(═O)NH, —C(═W)NHSO₂—, where
R⁶ represents hydrogen, methyl, ethyl, n-propyl, isopropyl, n-butyl, isobutyl, sec-butyl, tert-butyl, methoxymethyl, ethoxymethyl, propoxymethyl, methylcarbonyl, ethylcarbonyl, n-propylcarbonyl, isopropylcarbonyl, sec-butylcarbonyl, tert-butylcarbonyl, methoxycarbonyl, ethoxycarbonyl, n-propoxycarbonyl, isopropoxycarbonyl, sec-butoxycarbonyl, tert-butoxycarbonyl, cyanomethyl, 2-cyanoethyl;
m assumes the value 1;
Q represents hydrogen, methyl, ethyl, n-propyl, 1-methylethyl, 1,1-dimethylethyl, 1-methylpropyl, 2-methylpropyl, 2-methylbutyl, hydroxymethyl, 2-hydroxypropyl, cyanomethyl, 2-cyanoethyl, 2-fluoroethyl, 2,2-difluoroethyl, 2,2,2-trifluoroethyl, 1-trifluoromethylethyl, 2,2-difluoropropyl, 2,2-dimethyl-3-fluoropropyl, cyclopropyl, cyclobutyl, cyclopentyl, cyclohexyl, 1-cyclopropylethyl, bis(cyclopropyl)methyl, 2,2-dimethylcyclopropylmethyl, 2-phenylcyclopropyl, 2,2-dichlorocyclopropyl, trans-2-chlorocyclopropyl, cis-2-chlorocyclopropyl, 2,2-difluorocyclopropyl, trans-2-fluorocyclopropyl, cis-2-fluorocyclopropyl, trans-4-hydroxycyclohexyl, 4-trifluoromethylcyclohexyl, prop-2-enyl, 2-methylprop-2-enyl, prop-2-ynyl, 1,1-dimethylbut-2-ynyl, 3-chloroprop-2-enyl, 3,3-dichloro-1,1-dimethylprop-2-enyl, oxetan-3-yl, isoxazol-3-ylmethyl, 1,2,4-triazol-3-ylmethyl, 3-methyloxetan-3-ylmethyl, benzyl, 2,6-difluorophenylmethyl, 3-fluorophenylmethyl, 2-fluorophenylmethyl, 2,5-difluorophenylmethyl, 1-phenylethyl, 4-chlorophenylethyl, 2-trifluoromethylphenylethyl, 1-pyridin-2-ylethyl, pyridin-2-ylmethyl, 5-fluoropyridin-2-ylmethyl, pyrimidin-2-ylmethyl, methoxy, 2-ethoxyethyl, 2-(methylsulphanyl)ethyl, 1-methyl-2-(ethylsulphanyl)ethyl, methoxycarbonyl, methoxycarbonylmethyl, NH₂, N-ethylamino, N-allylamino, N,N-dimethylamino, N,N-diethylamino; or
Q represents hydrogen, methyl, ethyl, n-propyl, 1-methylethyl, 1,1-dimethylethyl, 1-methylpropyl, 2-methylpropyl, 2-methylbutyl, hydroxymethyl, 2-hydroxypropyl, cyanomethyl, 2-cyanoethyl, 2-fluoroethyl, 2,2-difluoroethyl, 2,2,2-trifluoroethyl, 1-trifluoromethylethyl, 2,2-difluoropropyl, 2,2-dimethyl-3-fluoropropyl, cyclopropyl, cyclobutyl, cyclopentyl, cyclohexyl, 1-cyclopropylethyl, bis(cyclopropyl)methyl, 2,2-dimethylcyclopropylmethyl, 2-phenylcyclopropyl, 2,2-dichlorocyclopropyl, trans-2-chlorocyclopropyl, cis-2-chlorocyclopropyl, 2,2-difluorocyclopropyl, trans-2-fluorocyclopropyl, cis-2-fluorocyclopropyl, trans-4-hydroxycyclohexyl, 4-trifluoromethylcyclohexyl, prop-2-enyl, 2-methylprop-2-enyl, prop-2-ynyl, 1,1-dimethylbut-2-ynyl, 3-chloroprop-2-enyl, 3,3-dichloroprop-2-enyl, 3,3-dichloro-1,1-dimethylprop-2-enyl, oxetan-3-yl, isoxazol-3-ylmethyl, 1,2,4-triazol-3-ylmethyl, 3-methyloxetan-3-ylmethyl, benzyl, 2,6-difluorophenylmethyl, 3-fluorophenylmethyl, 2-fluorophenylmethyl, 2,5-difluorophenylmethyl, 1-phenylethyl, 4-chlorophenylethyl, 2-trifluoromethylphenylethyl, 1-pyridin-2-ylethyl, pyridin-2-ylmethyl, 5-fluoropyridin-2-ylmethyl, pyrimidin-2-ylmethyl, methoxy, 2-ethoxyethyl, 2-(methylsulphanyl)ethyl, 1-methyl-2-(ethylsulphanyl)ethyl, 2-methyl-1-(methylsulphanyl)propan-2-yl, methoxycarbonyl, methoxycarbonylmethyl, NH₂, N-ethylamino, N-allylamino, N,N-dimethylamino, N,N-diethylamino;
Z represents hydrogen, chlorine, bromine, iodine, cyano, nitro, methyl, ethyl, n-propyl, isopropyl, n-butyl, isobutyl, sec-butyl, tert-butyl, ethenyl, 1-propenyl, 2-propenyl, ethynyl, 1-propynyl, 1-butynyl, difluoromethyl, trichloromethyl, chlorodifluoromethyl, dichlorofluoromethyl, difluoromethyl, chloromethyl, bromomethyl, 1-fluoroethyl, 1-fluoro-1-methylethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl, pentafluoro-tert-butyl, heptafluoro-n-propyl, heptafluoroisopropyl, nonafluoro-n-butyl, trifluoromethoxy-1,1,2,2-tetrafluoroethoxydifluoromethyl, trifluoromethylthio, trifluoromethylsulphinyl, trifluoromethylsulphonyl, methoxy, ethoxy, n-propoxy, trifluoromethoxy, difluoromethoxy, cyclopropyl, cyclobutyl, 2,2,2-trifluoroethoxy, 1-trifluoromethylethoxy, 3,3,3,2,2-pentafluoropropoxy, 4-fluorophenyl, 4-chlorophenyl, 4-trifluoromethylphenyl, 2,2,2-trifluoroethyl, 2,2-difluoro-1-methylcyclopropyl; or
Z represents hydrogen, chlorine, bromine, iodine, cyano, nitro, methyl, ethyl, n-propyl, isopropyl, n-butyl, isobutyl, sec-butyl, tert-butyl, ethenyl, 1-propenyl, 2-propenyl, ethynyl, 1-propynyl, 1-butynyl, difluoromethyl, trichloromethyl, chlorodifluoromethyl, dichlorofluoromethyl, trifluoromethyl, chloromethyl, bromomethyl, 1-fluoroethyl, 1-fluoro-1-methylethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl, pentafluoro-tert-butyl, heptafluoro-n-propyl, heptafluoroisopropyl, nonafluoro-n-butyl, trifluoromethoxy-1,1,2,2-tetrafluoroethoxydifluoromethyl, trifluoromethylthio, trifluoromethylsulphinyl, trifluoromethylsulphonyl, methoxy, ethoxy, n-propoxy, trifluoromethoxy, difluoromethoxy, cyclopropyl, cyclobutyl, 2,2,2-trifluoroethoxy, 1-trifluoromethylethoxy, 3,3,3,2,2-pentafluoropropoxy, 4-fluorophenyl, 4-chlorophenyl, 4-trifluoromethyphenyl, 2,2,2-trifluoroethyl, 2,2-difluoro-1-methylcyclopropyl, phenyl, methoxymethyl, cyclopropyl(fluoro)methyl, 2,4-dichlorophenyl, 4-trifluoromethoxyphenyl, 2-chlorophenyl, 3,5-bis(trifluoromethyl)phenyl, (1,1,1,3,3,3-hexafluoropropan-2-yl)oxy
furthermore
L, Q and R⁴ together with the carbon atoms to which they are attached may form an optionally substituted 5- or 6-membered ring which optionally contains 0, 1 or 2 nitrogen atoms and/or 0 or 1 oxygen atom and/or 0 or 1 sulphur atom.

4. Active compound combinations according to claim 1 in which component B is selected from the group consisting of: acrinathrin, alpha-cypermethrin, betacyfluthrin, cyhalothrin, cypermethrin, deltamethrin esfenvalerate, etofenprox, fenpropathrin, fenvalerate, flucythrinat, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (Rynaxypyr), Cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinetoram, acephate, triazophos, profenofos, fenamiphos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, metamidophos, methiocarb, sulfoxaflor.

5. Active compound combinations according to claim 1 in which component B is selected from the group consisting of: azoxystrobin, boscalid, penflufen, carbendazim, carboxin, fenamidone, fludioxonil, fluopicolide, fluoxastrobin, fluquinconazole, flutriafol, ipconazole, iprodione, isotianil, mefenoxam, metalaxyl, metominostrobin, pencycuron, prochloraz, prothioconazole, pyraclostrobin, pyrimethanil, sedaxane, silthiopham, tebuconazole, thiram, tolylfluanid, triadimenol, triazoxide, trifloxystrobin, triflumuron, triticonazole.

6. A method for controlling animal pests, comprising contacting said pests with an active compound combination according to claim 1.

7. A method for controlling unwanted microorganisms, comprising contacting said organisms with an active compound combination according to claim 1.

8. A method for the treatment of seed, comprising contacting said seed with an active compound combination according to claim 1.

9. A method for the treatment of transgenic plants, comprising contacting the plants with an active compound combination according to claim 1.

10. Process for preparing a crop protection composition, characterized in that an active compound combination according to claim 1 is mixed with extenders and/or surfactants.
